(19) United States
(12) Patent Application Publication
(10) Pub. No.: US 2026/0080587 A1
(43) Pub. Date: Mar. 19, 2026

(54) IMAGE EDITING USING PROMPT-AWARE CONTENT SEGMENTATION MASKS AND MASK-AWARE CONTENT-GENERATION

(71) Applicant: ADOBE INC., San Jose, CA (US)

(72) Inventors: Anubhav JAIN, Faridabad (IN); Shivam MISHRA, Kanpur (IN); Nishant RAI, Bangalore (IN)

(21) Appl. No.: 18/986,489

(22) Filed: Dec. 18, 2024

(30) Foreign Application Priority Data
Sep. 19, 2024 (IN) 202411070789

(51) Int. Cl. G06T 11/60; G06T 7/12; G06T 7/33

(52) U.S. Cl. CPC G06T 11/60; G06T 7/12; G06T 7/337; G06T 2207/20084

(57) ABSTRACT

Methods and systems are provided for image editing using prompt-aware content segmentation masks and mask-aware content generation. In embodiments described herein, an image, prompt, and selection to replace a selected type of content in the image with generated content is received. An image-generating model generates a generated image based on the prompt and image. A content mask extraction model extracts a first content mask from the image and a second content mask from the generated image based on the selected type of content. A refined content mask is generated by geometrically transforming the second content mask with respect to the first content mask and combing the two content masks. The image, prompt, and refined content mask are applied to a mask-aware content generating model to generate content within the refined content mask. The input image with the generated content within the refined content mask is displayed.

### CROSS REFERENCE TO RELATED APPLICATIONS

This application claims the benefit of priority to Indian Application No. 202411070789 filed on Sep. 19, 2024, which is incorporated herein by reference in its entirety.

### BACKGROUND

When editing images, such as photographs or video frames, digital artists will often isolate areas of an image for editing using masks. Masks allow digital artists to manipulate portions of an image in a nondestructive manner so that the pixels underneath the mask are not permanently altered or deleted. While masks are particularly useful for editing images, the manual process of creating masks is very tedious and requires advanced expertise.

### SUMMARY

Various aspects of the technology described herein are generally directed to systems, methods, and computer storage media for, among other things, image editing using prompt-aware content segmentation masks and mask-aware content generation. For example, a user inputs an image into an image processing application and selects a type of content that the user desires to edit, such as clothing in the image. The user inputs a prompt with a textual description describing how the user desires to edit the selected type of content. The input image and input prompt are applied to an image-generating model (e.g., an image-generating text-to-image diffusion model) to generate a generated image corresponding to a new image. The input image and the generated image are applied to a machine learning model trained to extract content masks from detected content in images for the selected type of content, such as machine learning model trained to extract clothing masks from detected clothing in images. The machine learning model extracts a content mask from detected content in the input image and a content mask from detected content in the generated image. The input image and the generated image are also applied to a reference-point detection model, such as a human landmark detection model, to identify reference points, such as human pose landmarks, from the input image and the generated image. A transformation matrix that maps the reference points of the generated image to the reference points of the input image is applied to the content mask from the detected content in the generated image to geometrically transform the content mask from the detected content in the generated image with respect to the content mask from the detected content in the input image. A refined content mask is generated by combining the geometrically-transformed content mask from the detected content in the generated image with the content mask from the detected content in the input image. The input image, input prompt, and refined content mask are applied to a mask-aware content-generating model (e.g., a mask-aware text-to-image diffusion model) to generate content within the refined content mask for the input image. The input image with the generated content within the refined content mask is then displayed to the user.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 depicts a diagram of an environment in which one or more embodiments of the present disclosure can be practiced, in accordance with various embodiments of the present disclosure.

FIG. 2 depicts an example configuration of an operating environment in which some implementations of the present disclosure can be employed, in accordance with various embodiments of the present disclosure.

FIG. 3A provides an example diagram of image editing using prompt-aware content segmentation masks and mask-aware content generation, in accordance with embodiments of the present disclosure.

FIG. 3B provides an example diagram of generating a generated image by an image-generating component with respect to the example diagram of FIG. 3A, in accordance with embodiments of the present disclosure.

FIG. 3C provides an example diagram of extracting a content mask from an input image and a content mask from a generated image by a content mask extraction component with respect to the example diagram of FIG. 3A, in accordance with embodiments of the present disclosure.

FIG. 3D provides an example diagram of generating a refined content mask by a content mask refinement component based on a content mask from an input image and a content mask from a generated image with respect to the example diagram of FIG. 3A, in accordance with embodiments of the present disclosure.

FIG. 3E provides an example diagram of editing an input image using mask-aware content-generating component to generate content within a refined content mask with respect to the example diagram of FIG. 3A, in accordance with embodiments of the present disclosure.

FIG. 4 is a process flow showing a method for image editing using prompt-aware content segmentation masks and mask-aware content generation, in accordance with embodiments of the present disclosure.

FIG. 5 is a process flow showing a method for generating a refined content mask based on a content mask from an input image and a content mask from a generated image for image editing using prompt-aware content segmentation masks and mask-aware content generation, in accordance with embodiments of the present disclosure.

FIG. 6 is a process flow showing a method for image editing using prompt-based clothing mask generation and clothing content filling, in accordance with embodiments of the present disclosure.

FIG. 7 is a block diagram of an example computing device in which embodiments of the present disclosure can be employed.

FIG. 8 shows an example of a guided diffusion model according to aspects of the present disclosure.

FIG. 9 shows an example of a U-Net according to aspects of the present disclosure.

FIG. 10 shows an example of a method for conditional media generation according to aspects of the present disclosure.

FIG. 11 shows a diffusion process according to aspects of the present disclosure.

FIG. 12 shows a flow diagram depicting an algorithm as a step-by-step procedure for training a machine-learning model according to aspects of the present disclosure.

FIG. 13 shows an example of a method for training a diffusion model according to aspects of the present disclosure.

FIG. 14A shows an example of a mask-aware content-generating apparatus according to aspects of the present disclosure.

FIG. 14B shows an example of an image-generating apparatus according to aspects of the present disclosure.

### DETAILED DESCRIPTION

### Overview

A “mask” generally refers to selected pixels in an image that can be used to define a region of an image that will be affected by editing operation, while leaving the rest of the image unaffected by the edition operation. For example, a mask can be defined for the background of the image so that a user can edit the background of the image without editing the rest of the image, such as the subject of the image. A “content segmentation mask,” also referred to herein as a “content mask,” generally refers to a mask for selected content to distinguish specific content from the rest of the image, such as the background of the image or other elements of the image. For example, a content mask for clothing, which may be referred to herein as “a clothing mask,” would include the set of pixels from an image that correspond to detected clothing in the image, such as a detected shirt, pants, dress, shoes, accessories, and/or the like. As another example, a content mask for hair, which may be referred to herein as “a hair mask,” would include the set of pixels from an image that correspond to detected hair in the image.

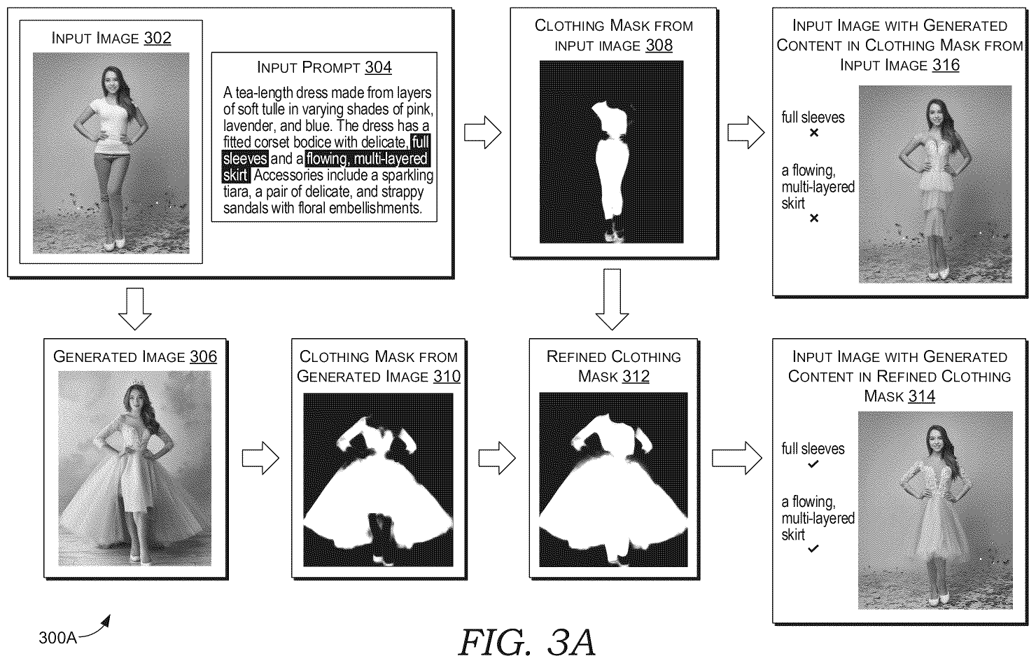

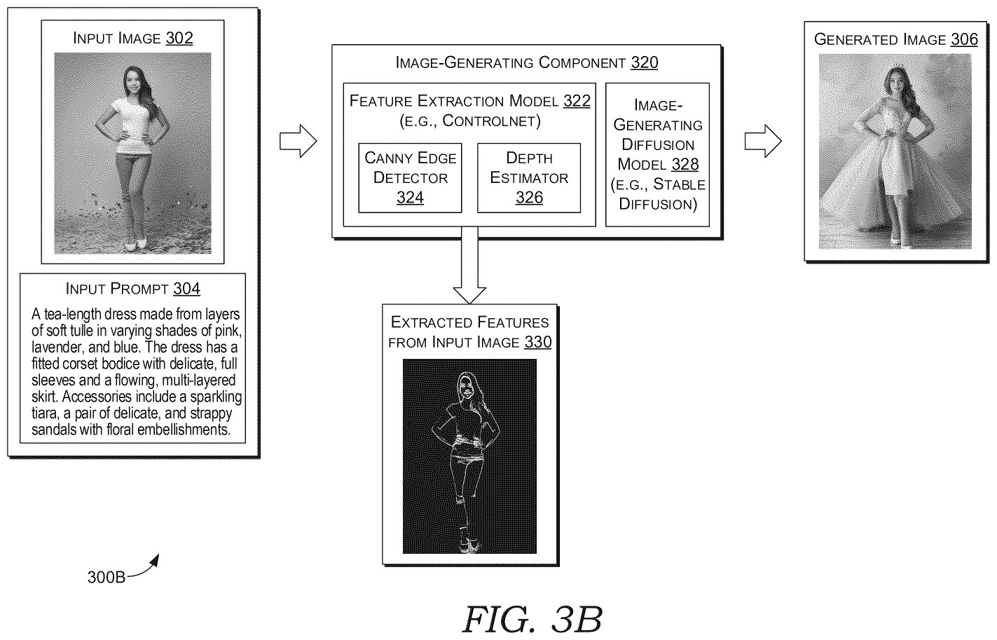

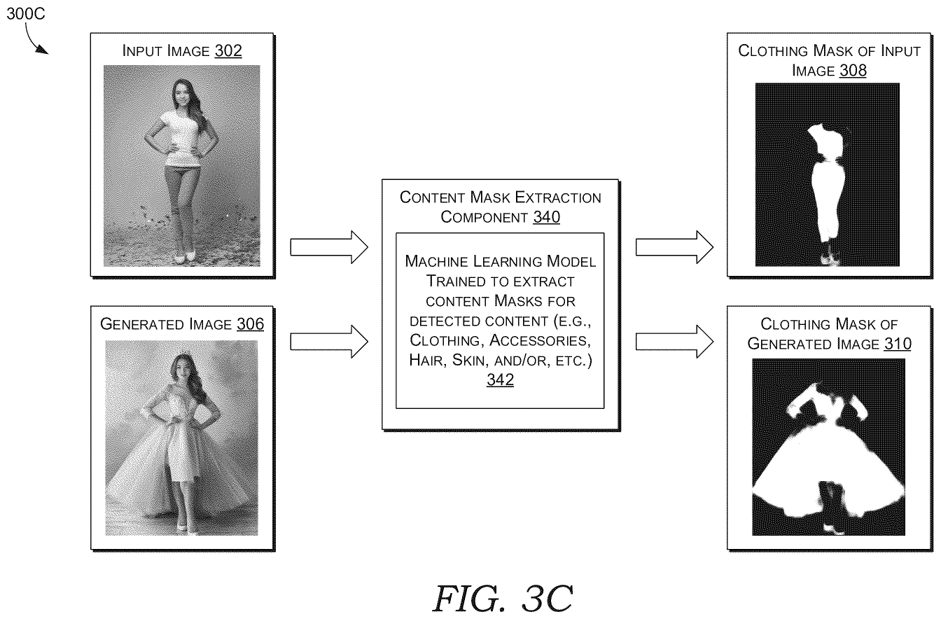

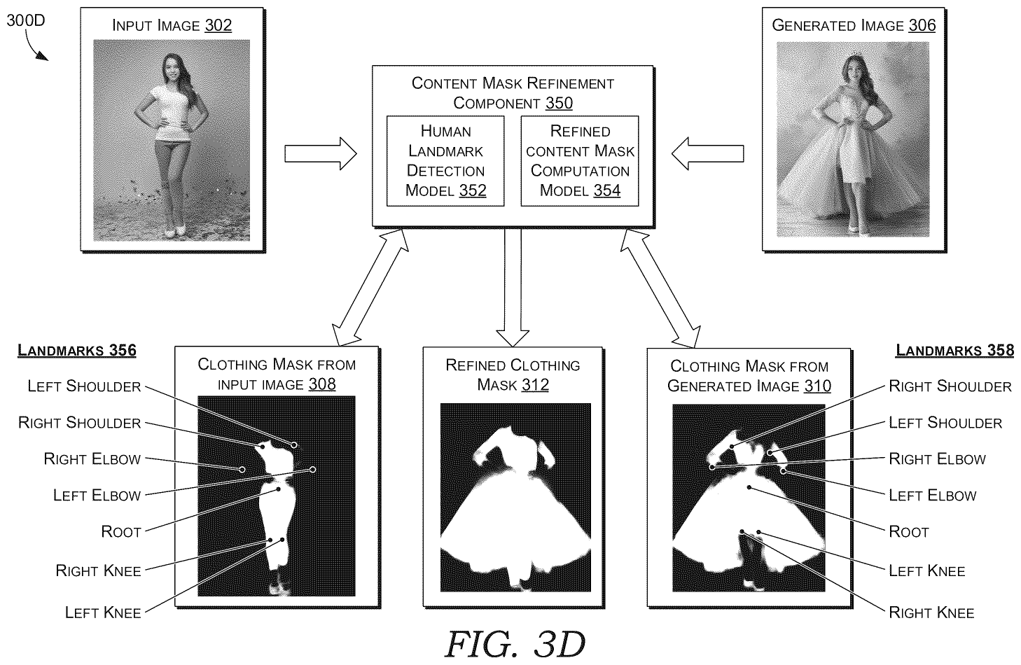

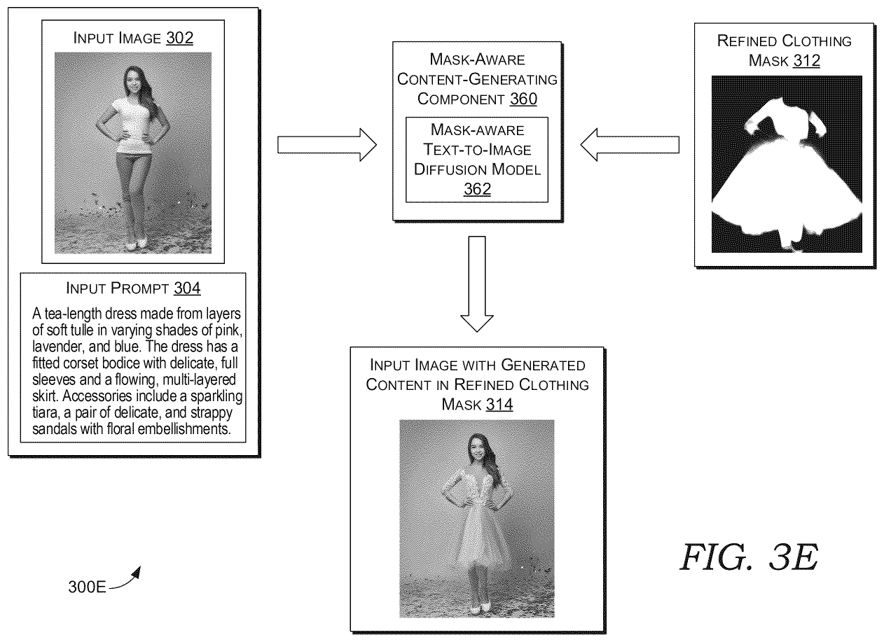

As described above, while masks are particularly useful for editing images, the manual process of creating masks is very tedious and requires advanced expertise. Some prior techniques exist that utilize machine learning models trained to detect content and generate corresponding content masks for the corresponding content. However, when implementing text-to-image diffusion models to generate content in a content mask, the text-to-image diffusion model is limited to the content mask as defined by the boundaries of the detected content of the input image. For example, if a clothing mask is detected corresponding to a dress with half-sleeves, the text-to-image diffusion model will not be able to generate a dress with full-sleeves within the corresponding clothing mask (e.g., as shown by the example 316 of FIG. 3A) as the content mask is defined by boundaries of the dress with half-sleeves.

As a result, if a user, such as a digital artist, desires to edit an image using a text-to-image diffusion model based on an input textual prompt and input image, the user must either (1) manually create a content mask for the input image and prompt the model to generate content in the manually-created content mask, (2) prompt the model to generate content for a content mask that is limited by the boundaries of the detected content available in the input image, or (3) prompt the model to generate an entirely new image using a text-to-image diffusion model, thereby losing desired image data (e.g., as shown by the differences between the subject and background of input image 302 and generated image 306 in the example of FIG. 3A). When undesired generated content is generated by a text-to-image diffusion model, such as undesired generated content caused by a content mask that is limited by the boundaries of the detected content of the input image or undesired generated content caused by generating an entirely new image, the user must manually edit the image to fix the undesired generated content in the image.

Accordingly, unnecessary computing resources are utilized to manually create a content mask or manually edit images to fix undesired generated content in conventional implementations. For example, computing and network resources are unnecessarily consumed to facilitate the tedious, manual creation of content masks or the tedious, manual editing of undesired generated content in an image. For instance, computer input/output operations are unnecessarily increased to manually create a content mask or manually edit images to fix undesired generated content. Further, when image data is located in a disk array, there is unnecessary wear placed on the read/write head of the disk of the disk array each time the information related to the image is accessed in order to manually create a content mask or manually edit images to fix undesired generated content. Even further, the processing of operations to manually create a content mask or manually edit images to fix undesired generated content decreases the throughput for a network, increases the network latency, and increases packet generation costs when the image data is located over a network.

As such, embodiments of the present disclosure are directed to image editing using prompt-aware content segmentation masks and mask-aware content generation in an efficient and effective manner. By generating a content mask for detected content in an input image where the content mask is also determined based on parameters of an input prompt, content can be efficiently and effectively generated to fill the content mask of the input image that meets the parameters of the input prompt that is not limited by the detected content of the input image.

Generally, and at a high level, embodiments described herein facilitate image editing using prompt-aware content segmentation masks and mask-aware content generation. For example, a user inputs an image into an image processing application and selects a type of content that the user desires to edit, such as clothing in the image. The user inputs a prompt with a textual description describing how the user desires to edit the selected type of content. The input image and input prompt are applied to an image-generating model (e.g., an image-generating text-to-image diffusion model) to generate a generated image corresponding to a new image. The input image and the generated image are applied to a machine learning model trained to extract content masks from detected content in images for the selected type of content, such as machine learning model trained to extract clothing masks from detected clothing in images. The machine learning model extracts a content mask from detected content in the input image and a content mask from detected content in the generated image. The input image and the generated image are also applied to a reference-point detection model, such as a human landmark detection model, to identify reference points, such as human pose landmarks, from the input image and the generated image. A transformation matrix that maps the reference points of the generated image to the reference points of the input image is applied to the content mask from the detected content in the generated image to geometrically transform the content mask from the detected content in the generated image with respect to the content mask from the detected content in the input image. A refined content mask is generated by combining the geometrically-transformed content mask from the detected content in the generated image with the content mask from the detected content in the input image. The input image, input prompt, and refined content mask are applied to a mask-aware content-generating model (e.g., a mask-aware text-to-image diffusion model) to generate content within the refined content mask for the input image. The input image with the generated content within the refined content mask is then displayed to the user.

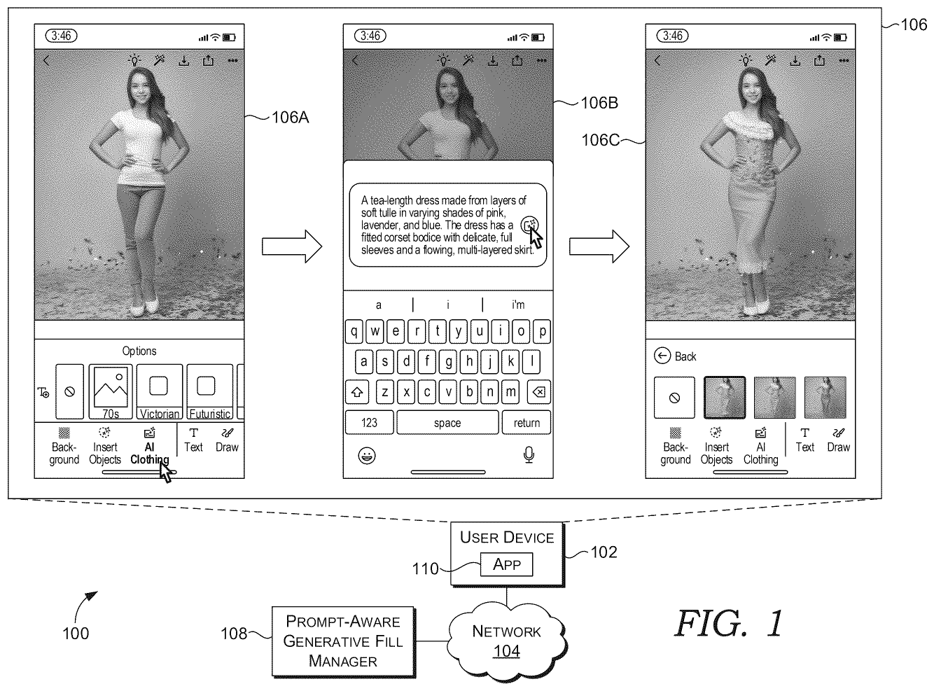

In operation, a user, such as a digital artist, inputs an image into an image processing application, such as a graphics editor and/or a video editor. Some example applications that may be used for image processing include ADOBE PHOTOSHOP®, and ADOBE EXPRESS®, to name a few examples. The user then designates a type of content that the user desires to edit. For example, the user can select an option to edit the clothing and/or hair in the image via a user interface (UI) of the image processing application. An example of an image input into an image processing application and a selection to edit clothing in the image is shown via UI 106A described with reference to FIG. 1. The user enters a prompt describing parameters that indicate how the user desires to edit the selected type of content via a UI of the image processing application. For example, the user can provide a textual description of details and/or a secondary image to describe parameters regarding how content should be generated in the input image. For example, the user can indicate a type of clothing (e.g., a dress), various stylistic features of the clothing (e.g., long sleeves), a type of hairstyle, and/or the like in the prompt. An example of a prompt input into an image processing application is shown via UI 106B described with reference to FIG. 1.

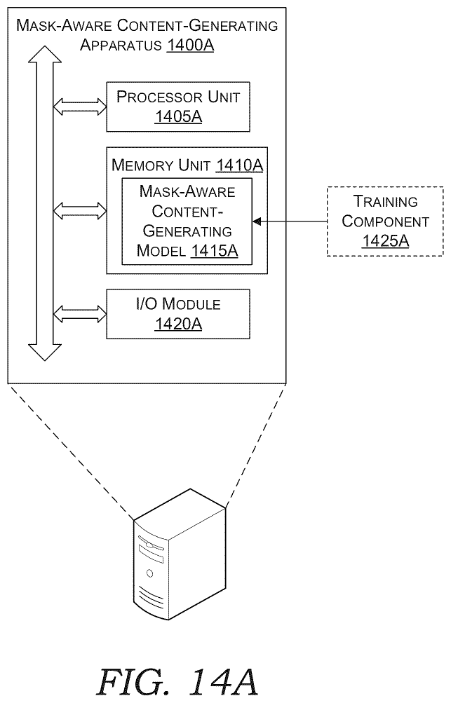

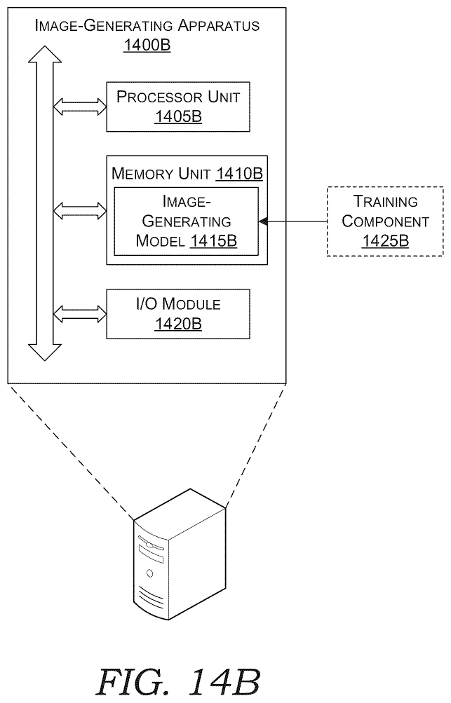

The image processing application applies the input image and input prompt to an image-generating model (e.g., image-generating model 1415B described with reference to FIG. 14B), such as an image-generating text-to-image diffusion model, to generate a generated image corresponding to a new image. An image-generating model generally refers to a generative artificial intelligence (AI) model that takes a prompt, such as a textual prompt, an input image and extracted features from the input image, and generates a new image. In some embodiments, the image-generating model includes a feature extraction model, such as ControlNet, and an image-generating diffusion model, such as Stable Diffusion. The feature extraction model extracts structural features from the input image, such as edges, poses, points, and/or the like to guide the output of the image-generating model. An example of an edge map extracted by a feature extraction model is shown at 330 described with reference to FIG. 3B. The input image, extracted structural features, and input prompt are applied to the image-generating diffusion model to generate a generated image corresponding to a new image by iteratively refining the generated image based on the extracted structural features and the input prompt. An example of a generated image generated by an image-generating model is shown at 306 described with reference to FIG. 3A and FIG. 3B. As can be understood, the individual and background shown in input image 302 is different than the individual and background shown in generated image 306.

The image processing application applies the input image and the generated image to a machine learning model trained to extract content masks from detected content in images for the selected type of content. For example, when the user selects the option to edit the clothing in the image via the UI of the image processing application, the image processing application applies the input image and the generated image to a machine learning model trained to extract clothing masks from detected clothing (e.g., and/or other fashion items) in images. A content mask from detected content in the input image and a content mask from detected content in the generated image is then extracted utilizing the machine learning model. An example of a clothing mask from detected clothing in an input image and a clothing mask from detected clothing in a generated image that are extracted by a clothing mask extraction model is shown at 308 and 310, respectively, described with reference to FIG. 3A and FIG. 3C.

The image processing application applies the input image and the generated image to a reference-point detection model, such as a human landmark detection model, to identify reference points, such as human pose landmarks, corresponding to the detected content in the input image and the generated image. For example, when the user selects the option to edit the clothing in the image via the UI of the image processing application, the image processing application applies the input image and the generated image to a human landmark detection model to identify human pose landmarks as reference points corresponding to the detected clothing in the input image and the generated image. An example of human pose landmarks identified from an input image (e.g., with respect to a clothing mask from detected content in the input image) and human pose landmarks identified from a generated image (e.g., with respect to a clothing mask from detected content in the generated image) that are identified by a human landmark detection model are shown at 356 and 358, respectively, described with reference to FIG. 3D.

The image processing application maps the reference points of the generated image to the reference points of the input image to geometrically transform the content mask from the detected content in the generated image with respect to the content mask from the detected content in the input image. By applying a geometric transformation of the content mask from the detected content in the generated image based on the mapping of reference points between the generated image and the input image, the content mask from the detected content in the generated image can be aligned with the content mask from the detected content in the input image. For example, the geometric transformation can include changes to the position, size, orientation, shape, and/or the like of the content mask from the detected content in the generated image through operations such as translation, scaling, rotation, shearing, and/or the like to align the content masks and/or reference points. In certain embodiments, a transformation matrix is used to map the reference points of the generated image to the reference points of the input image and geometrically transform the content mask from the detected content in the generated image with respect to the content mask from the detected content in the input image. In certain embodiments, the geometric transformation corresponds to an affine transformation that includes a combination of operations such as translation, scaling, rotation, shearing, and/or the like to align the content masks and/or reference points.

The image processing application generates a refined content mask by combining the geometrically-transformed content mask from the detected content in the generated image with the content mask from the detected content in the input image. In certain embodiments, a union operation is applied to the geometrically-transformed content mask from the detected content in the generated image and the content mask from the detected content in the input image to generate the refined content mask. In certain embodiments, post-processing operations are performed to generate the refined content mask after combining the geometrically-transformed content mask from the detected content in the generated image with the content mask from the detected content in the input image. In certain embodiments, post-processing operations include operations such as dilation, alignment, thresholding, and/or the like to align the refined content mask with the content mask from the detected content in the input image. An example of a refined content mask generated by a mask refinement model by combining the geometrically-transformed content mask from the detected content in the generated image with the content mask from the detected content in the input image is shown at 312 described with reference to FIG. 3D.

The image processing application applies the input image, input prompt, and refined content mask to a mask-aware content-generating model (e.g., mask-aware content-generating model 1415A described with reference to FIG. 14A), such as a mask-aware text-to-image diffusion model, to generate content within the refined content mask for the input image. A mask-aware content-generating model generally refers to a generative AI model that takes a prompt, such as a textual prompt, an input image and a mask of the input image, and generates content within boundaries defined by the mask. In certain embodiments, the mask-aware content-generating model can be trained and/or fine-tuned to generate the selected type of content. For example, when the user selects the option to edit the clothing in the image via the UI of the image processing application, the image processing application applies the input image, input prompt, and refined clothing mask to a mask-aware content-generating model trained and/or fine-tuned to generate clothing content within boundaries defined by the refined clothing mask.

An example of an input image with content generated in a refined content mask by a mask-aware content-generating model is shown at 314 described with reference to FIG. 3A and FIG. 3E. As can be understood, the individual and background shown in input image 302 is the same as the individual and background shown in input image with generated content in refined clothing mask 314. In this regard, as the refined content mask includes structural details from the detected content in the input image and contextual details based on the input prompt from the detected content in the generated image, the output from the mask-aware content generating model integrates with other elements in the input image outside of the refined content mask, such as the person and/or background in the image, while reflecting the context of the input prompt.

The image processing application outputs the input image with the generated content within the refined content mask for display via a UI of the image processing application to the user. An example of an input image with generated content within a refined content mask is shown via UI 106C of FIG. 1.

Advantageously, efficiencies of computing and network resources can be enhanced using implementations described herein. In particular, the automated process for image editing using prompt-aware content segmentation masks and mask-aware content generation provides for a more efficient use of computing and network resources (e.g., less operations, higher throughput and reduced latency for a network, less packet generation costs, etc.) than prior methods. For example, using implementations described herein enhances efficiencies of computing and network resources with respect to prior methods of manually creating a content mask or manually editing images to fix undesired generated content.

### Overview of Exemplary Environments for Image Editing Using Prompt-Aware Content Segmentation Masks and Mask-Aware Content Generation

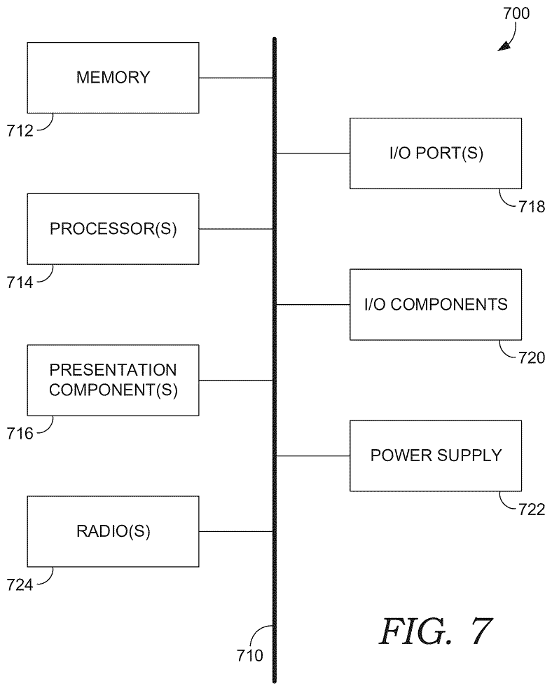

Having provided an overview of the technology described herein, reference is now made to FIG. 1. FIG. 1 depicts an example configuration of an operating environment in which some implementations of the present disclosure can be employed. It should be understood that this and other arrangements described herein are set forth only as examples. Other arrangements and elements (e.g., machines, interfaces, functions, orders, and groupings of functions, etc.) can be used in addition to or instead of those shown, and some elements can be omitted altogether for the sake of clarity. Further, many of the elements described herein are functional entities that can be implemented as discrete or distributed components or in conjunction with other components, and in any suitable combination and location. Various functions described herein as being performed by one or more entities can be carried out by hardware, firmware, and/or software. For instance, some functions can be carried out by a processor executing instructions stored in memory as further described with reference to FIG. 7.

It should be understood that operating environment 100 shown in FIG. 1 is an example of one suitable operating environment. Among other components not shown, operating environment 100 includes a user device 102, application 110, network 104, and prompt-aware generative fill manager 108. Operating environment 100 also shows an example 106 showing an example of image editing using prompt-aware content segmentation masks and mask-aware content generation via application 110. Example 106 includes an example UI 106A of an image input into application 110 and a selection to edit clothing in the image by a user. Example 106 also includes an example UI 106B of a prompt input into application 110 by a user. Example 106 also includes an example UI 106C of the input image with generated content within a refined content mask output by application 110. Each of the components shown in FIG. 1 can be implemented via any type of computing device, such as one or more of computing device 700 described in connection to FIG. 7, for example.

These components can communicate with each other via network 104, which can be wired, wireless, or both. Network 104 can include multiple networks, or a network of networks, but is shown in simple form so as not to obscure aspects of the present disclosure. By way of example, network 104 can include one or more wide area networks (WANs), one or more local area networks (LANs), one or more public networks such as the Internet, one or more private networks, one or more cellular networks, one or more peer-to-peer (P2P) networks, one or more mobile networks, or a combination of networks. Where network 104 includes a wireless telecommunications network, components such as a base station, a communications tower, or even access points (as well as other components) can provide wireless connectivity. Networking environments are commonplace in offices, enterprise-wide computer networks, intranets, and the Internet. Accordingly, network 104 is not described in significant detail.

It should be understood that any number of user devices, servers, and other components can be employed within operating environment 100 within the scope of the present disclosure. Each can comprise a single device or multiple devices cooperating in a distributed environment.

User device 102 can be any type of computing device capable of being operated by an individual(s) (e.g., any user edits images, such as photographs or video frames of a video, such as a digital artist, etc.). For example, in some implementations, such devices are the type of computing device described in relation to FIG. 7. By way of example and not limitation, user devices can be embodied as a personal computer (PC), a laptop computer, a mobile device, a smartphone, a tablet computer, a smart watch, a wearable computer, a personal digital assistant (PDA), an MP3 player, a global positioning system (GPS) or device, a video player, a handheld communications device, a gaming device or system, an entertainment system, a vehicle computer system, an embedded system controller, a remote control, an appliance, a consumer electronic device, a workstation, any combination of these delineated devices, or any other suitable device.

The user device 102 can include one or more processors, and one or more computer-readable media. The computer-readable media may include computer-readable instructions executable by the one or more processors. The instructions may be embodied by one or more applications, such as application 110 shown in FIG. 1. Application 110 is referred to as single applications for simplicity, but its functionality can be embodied by one or more applications in practice.

Application 110 operating on user device 102 can generally be any image processing application that allows a user to edit images, such as photographs or videos frames of a video, such as a graphics editor or video editor. In some implementations, the application 110 comprises a web application, which can run in a web browser, and could be hosted at least partially server-side (e.g., via prompt-aware generative fill manager 108). In addition, or instead, the application 110 can comprise a dedicated application. In some cases, the application 110 is integrated into the operating system (e.g., as a service).

User device 102 can be a client device on a client-side of operating environment 100, while prompt-aware generative fill manager 108 can be on a server-side of operating environment 100. Prompt-aware generative fill manager 108 may comprise server-side software designed to work in conjunction with client-side software on user device 102 so as to implement any combination of the features and functionalities discussed in the present disclosure. An example of such client-side software is application 110 on user device 102. This division of operating environment 100 is provided to illustrate one example of a suitable environment, and it is noted there is no requirement for each implementation that any combination of user device 102 or prompt-aware generative fill manager 108 to remain as separate entities.

Application 110 operating on user device 102 can generally be any application capable of facilitating the exchange of information between the user device 102 and the prompt-aware generative fill manager 108 in displaying and exchanging information regarding input images, input prompts, content masks, generated content, and edited images. In some implementations, the application 110 comprises a web application, which can run in a web browser, and could be hosted at least partially on the server-side of environment 100. In addition, or instead, the application 110 can comprise a dedicated application. In some cases, the application 110 is integrated into the operating system (e.g., as a service). It is therefore contemplated herein that “application” be interpreted broadly.

At a high level, prompt-aware generative fill manager 108 performs various functionality to facilitate efficient and effective image editing using prompt-aware content segmentation masks and mask-aware content generation. The prompt-aware generative fill manager 108 can communicate with application 110 in order for application 110 to provide input images, provide input prompts, display content masks, display generated content, and/or display edited images. In this regard, prompt-aware generative fill manager 108 can receive data regarding an input image and input prompt from application 110 of the user device.

In operation, a user inputs an image into application 110 and selects a type of content that the user desires to edit. As can be understood from UI 106A, the user selects an option to edit clothing in the input image. The user inputs a prompt into application 110 with a textual description and/or secondary images designating how the user desires to edit the selected type of content. As can be understood from UI 106B, the user inputs a prompt with a textual description describing how the clothing should be generated in the image. The input image and input prompt are accessed by prompt-aware generative fill manager 108. The input image and input prompt are applied to an image-generating model (e.g., image-generating model 1415B described with reference to FIG. 14B) by prompt-aware generative fill manager 108 to generate a generated image corresponding to a new image. The input image and the generated image are applied to a machine learning model trained to extract content masks from detected content in images for the selected type of content by prompt-aware generative fill manager 108. The input image and the generated image are also applied to a reference-point detection model by prompt-aware generative fill manager 108 to identify reference points corresponding to the detected content in the input image and the generated image. Prompt-aware generative fill manager 108 maps the reference points of the generated image to the reference points of the input image to geometrically transform the content mask from the detected content in the generated image with respect to the content mask from the detected content in the input image. Prompt-aware generative fill manager 108 generates a refined content mask by combining the geometrically-transformed content mask from the detected content in the generated image with the content mask from the detected content in the input image. Prompt-aware generative fill manager 108 applies the input image, input prompt, and refined content mask to a mask-aware content-generating model (e.g., mask-aware content-generating model 1415A described with reference to FIG. 14A) to generate content within the refined content mask for the input image. The input image with the generated content within the refined content mask is then displayed to the user via application 110. As can be understood from UI 106C, the input image with the generated content within the refined content mask is displayed via application 110.

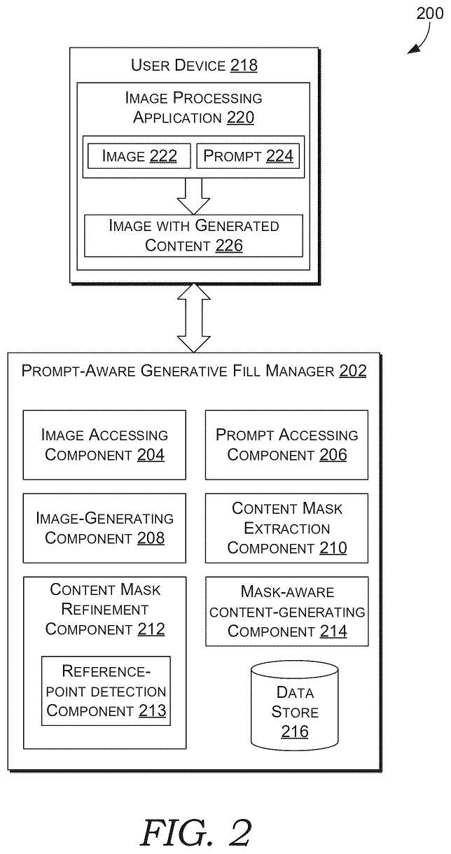

Prompt-aware generative fill manager 108 can be or include a server, including one or more processors, and one or more computer-readable media. The computer-readable media includes computer-readable instructions executable by the one or more processors. The instructions can optionally implement one or more components of prompt-aware generative fill manager 108, described in additional detail below with respect to prompt-aware generative fill manager 202 of FIG. 2. For example, prompt-aware generative fill manager 108 can include and/or implement mask-aware content-generating apparatus 1400A described in additional detail below with respect to FIG. 14A and image-generating apparatus 1400B described in additional detail below with respect to FIG. 14B.

For cloud-based implementations, the instructions on prompt-aware generative fill manager 108 can implement one or more components, and application 110 can be utilized by a user to interface with the functionality implemented on prompt-aware generative fill manager 108. In some cases, application 110 comprises a web browser. In other cases, prompt-aware generative fill manager 108 may not be required. For example, the components of prompt-aware generative fill manager 108 may be implemented completely on a user device, such as user device 102. In this case, prompt-aware generative fill manager 108 may be embodied at least partially by the instructions corresponding to application 110.

Thus, it should be appreciated that prompt-aware generative fill manager 108 may be provided via multiple devices arranged in a distributed environment that collectively provide the functionality described herein. Additionally, other components not shown may also be included within the distributed environment. In addition, or instead, prompt-aware generative fill manager 108 can be integrated, at least partially, into a user device, such as user device 102. Furthermore, prompt-aware generative fill manager 108 may at least partially be embodied as a cloud computing service.

Referring to FIG. 2, aspects of an illustrative prompt-aware generative fill system 200 are shown, in accordance with various embodiments of the present disclosure. At a high level, prompt-aware generative fill system 200 can facilitate image editing using prompt-aware content segmentation masks and mask-aware content generation to generate content within boundaries of a refined content mask of the input image that meets the parameters of the input prompt.

As shown in FIG. 2, prompt-aware generative fill manager 202 includes image accessing component 204, prompt accessing component 206, image-generating component 208, content mask extraction component 210, content mask refinement component 212 with reference-point detection component 213, and mask-aware content-generating component 214. A user inputs an image 222 and a prompt 224 into an image processing application 220 (e.g., application 110 of FIG. 1) on user device 218 (e.g., user device 102 of FIG. 1). The prompt-aware generative fill manager 202 facilitates image editing using prompt-aware content segmentation masks and mask-aware content generation to generate content within boundaries of a refined content mask of the input image that meets the parameters of the input prompt and outputs image with generated content 226. The prompt-aware generative fill manager 202 can communicate with the data store 216. The data store 216 is configured to store various types of information accessible by prompt-aware generative fill manager 202, or other server or component. The foregoing components of prompt-aware generative fill manager 202 can be implemented, for example, in operating environment 100 of FIG. 1. In particular, those components may be integrated into any suitable combination of user devices 102 and/or prompt-aware generative fill manager 108.

In embodiments, data sources, user devices (such as user device 102 of FIG. 1), and prompt-aware generative fill manager 202 can provide data to the data store 216 for storage, which may be retrieved or referenced by any such component. As such, the data store 216 can store computer instructions (e.g., software program instructions, routines, or services), data and/or models used in embodiments described herein, such as image-generating models, mask-aware content-generating models, content mask detections models, content mask extraction models, content mask refinement models, and/or the like. In some implementations, data store 216 can store information or data received or generated via the various components of prompt-aware generative fill manager 202 and provides the various components with access to that information or data, as needed. The information in data store 216 may be distributed in any suitable manner across one or more data stores for storage (which may be hosted externally).

The image accessing component 204 is generally configured to access an input image or selected image from an image editing application. In embodiments, image accessing component 204 can include rules, conditions, associations, models, algorithms, or the like to access an input image or selected image from an image editing application. The prompt accessing component 206 is generally configured to access an input prompt from an image editing application. In embodiments, prompt accessing component 206 can include rules, conditions, associations, models, algorithms, or the like to access an input prompt from an image editing application.

The image-generating component 208 is generally configured to generate a new image based on an input prompt, an input image, and/or extracted features from the input image. In embodiments, image-generating component 208 can include rules, conditions, associations, models, algorithms, or the like to generate a new image based on an input prompt, an input image, and/or extracted features from the input image, such as those described with respect to image-generating apparatus 1400B described with reference to FIG. 14B.

The content mask extraction component 210 is generally configured to extract content masks from detected content in images. In embodiments, content mask extraction component 210 can include rules, conditions, associations, models, algorithms, or the like to extract content masks from detected content in images. For example, content mask extraction component 210 may comprise a statistical model, fuzzy logic, neural network, finite state machine, support vector machine, logistic regression, clustering, or machine-learning techniques, similar statistical classification processes, or combinations of these to extract content masks from detected content in images, such as a machine learning model trained to extract clothing masks from detected clothing in images.

The content mask refinement component 212 is generally configured to geometrically transform a content mask to align the content mask with a different content mask and/or combine content masks. In embodiments, content mask refinement component 212 can include rules, conditions, associations, models, algorithms, or the like to geometrically transform a content mask to align the content mask with a different content mask and/or combine content masks. For example, content mask refinement component 212 may comprise a statistical model, fuzzy logic, neural network, finite state machine, support vector machine, logistic regression, clustering, or machine-learning techniques, similar statistical classification processes, or combinations of these to geometrically transform a content mask to align the content mask with a different content mask and/or combine content masks.

The reference-point detection component 213 is generally configured to identify reference points from images. In embodiments, reference-point detection component 213 can include rules, conditions, associations, models, algorithms, or the like to identify reference points from images. For example, reference-point detection component 213 may comprise a statistical model, fuzzy logic, neural network, finite state machine, support vector machine, logistic regression, clustering, or machine-learning techniques, similar statistical classification processes, or combinations of these to identify reference points from images, such as a human landmark detection model trained to identify human pose landmarks from a detected person in an image.

The mask-aware content-generating component 214 is generally configured to generate content within boundaries defined by a mask based on an input prompt, a mask, and/or an input image. In embodiments, mask-aware content-generating component 214 can include rules, conditions, associations, models, algorithms, or the like to generate content within boundaries defined by a mask based on an input prompt, a mask, and/or an input image, such as those described with respect to mask-aware content-generating apparatus 1400A described with reference to FIG. 14A.

Referring to FIG. 3A, example diagram 300A of image editing using prompt-aware content segmentation masks and mask-aware content generation is shown as an example implementation. In the example diagram 300A, an input image 302 and an input prompt 304 are applied to an image-generating model (image-generating component 208 described with reference to FIG. 2) to generate generated image 306. As can be understood, the individual and background shown in input image 302 is different than the individual and background shown in generated image 306. The generated image 306 and the input image 302 are applied to a clothing mask extraction model (e.g., content mask extraction component 210 described with reference to FIG. 2) to extract clothing masks from detected clothing in the generated image 306 and the input image 302 corresponding to clothing mask from generated image 310 and clothing mask from input image 308, respectively. A refined clothing mask 312 is generated by a clothing mask refinement model (e.g., content mask refinement component 212 described with reference to FIG. 2) based on the clothing masks 310 and 308 extracted from detected clothing in the in the generated image 306 and the input image 302. The input image 302, input prompt 304, and refined clothing mask 312 are applied to a mask-aware content-generating model (e.g., mask-aware content-generating component 214 described with reference to FIG. 2) to generate content within the refined clothing mask for the input image. The input image with generated content within the refined content mask 314 is output for display.

As can be understood, when the input image 302, input prompt 304, and clothing mask from input image 308 are applied to a mask-aware content-generating model, the generated content does not reflect the context of the input prompt 304 due to the boundary limitations of the detected clothing in the input image 302. However, as the refined clothing mask 312 includes structural details from the detected clothing in the input image 302 and contextual details based on the input prompt 304 from the detected clothing in the generated image 306, the output 316 from the mask-aware content generating model integrates with other elements in the input image 302 outside of the refined content mask 312, such as the person and/or background in the input image 302, while reflecting the context of the input prompt 304.

Returning to FIG. 2, in operation, a user, such as a digital artist, inputs an image 222 into an image processing application 220 (e.g., application 110 described with reference to FIG. 1), such as a graphics editor or video editor. Some example applications that may be used for image processing include ADOBE PHOTOSHOP®, and ADOBE EXPRESS®, to name a few examples. The user then designates a type of content that the user desires to edit. For example, the user can select an option to edit the clothing and/or hair in the image via UI of the image processing application 220. An example of an image input into an image processing application and a selection to edit clothing in the image is shown via UI 106A described with reference to FIG. 1. The user enters a prompt describing parameters that indicate how the user desires to edit the selected type of content via a UI of the image processing application 220. For example, the user can provide a textual description of details and/or a secondary image to describe parameters regarding how content should be generated in the input image. An example of a prompt input into an image processing application is shown via UI 106B described with reference to FIG. 1. As can be understood, the user can indicate a type of clothing (e.g., a dress), various stylistic features of the clothing (e.g., long sleeves), a type of hairstyle, and/or the like in the prompt.

Prompt-aware generative fill manager 202 accesses the input image 222 via image accessing component 204 and accesses the input prompt 224 via prompt accessing component 206. Prompt-aware generative fill manager 202 applies the input image 222 and input prompt 224 to image-generating component 208 (e.g., image-generating model 1415B described with reference to FIG. 14B) to generate a generated image corresponding to a new image. For example, image-generating component 208 can include an image-generating text-to-image diffusion model.

Referring to FIG. 3B, an example diagram 300B of generating a generated image by an image-generating component 320 is shown as an example implementation. In some embodiments, image-generating component 320 (e.g., image-generating component 208 described in connection with FIG. 2) includes a feature extraction model 322, such as ControlNet, and an image-generating diffusion model 328, such as Stable Diffusion. The feature extraction model 322 extracts structural features from the input image, such as edges, poses, points, and/or the like to guide the output of the image-generating model. For example, feature extraction model 322 extracts structural features via canny edge detector 324, depth estimator 326, and/or the like. An example of an edge map extracted by feature extraction model 322 is shown at 330. In some embodiments, the input image, 302 extracted structural features 330, and input prompt 304 are applied to the image-generating diffusion model 328 to generate a generated image 306 corresponding to a new image by iteratively refining the generated image 306 based on the extracted structural 330 features and the input prompt 304.

Returning to FIG. 2, prompt-aware generative fill manager 202 applies the input image 222 and the generated image (e.g., generated image 306 described in connection with FIGS. 3A-E) to content mask extraction component 210. Content mask extraction component 210 includes a machine learning model trained to extract content masks from detected content in images for the selected type of content. For example, when the user selects the option to edit the clothing in the image via the UI of the image processing application 220, prompt-aware generative fill manager 202 applies the input image 222 and the generated image (e.g., generated image 306 described in connection with FIGS. 3A-E) to a machine learning model trained to extract clothing masks from detected clothing (e.g., and/or other fashion items) in images of content mask extraction component 210. A content mask from detected content in the input image 222 and a content mask from detected content in the generated image (e.g., generated image 306 described in connection with FIGS. 3A-E) is then extracted via content mask extraction component 210.

Referring to FIG. 3C, an example diagram 300C of extracting a content mask from an input image and a content mask from a generated image by a content mask extraction component 340 is shown as an example implementation. As can be understood, input image 302 and generated image 306 are applied to content mask extraction component 340 (e.g., content mask extraction component 210 described in connection with FIG. 2). Content mask extraction component 340 includes a machine learning model 342 trained to extract content masks from detected content in images for the selected type of content (e.g., clothing, accessories, hair, skin, and/or others). A content mask 308 from detected content in the input image and a content mask 310 from detected content in the generated image is then extracted via content mask extraction component 340.

Returning to FIG. 2, prompt-aware generative fill manager 202 generates a refined content mask via content mask refinement component 212 based on the content masks extracted via content mask extraction component 210 from detected content in the input image 222 and detected content in the generated image (e.g., generated image 306 described in connection with FIGS. 3A-E).

In certain embodiments, the input image 222 and the generated image (e.g., generated image 306 described in connection with FIGS. 3A-E) are applied to a reference-point detection component 213 of content mask refinement component 212 to identify reference points corresponding to the detected content in the input image and the generated image. For example, when the user selects the option to edit the clothing in the image via the UI of the image processing application 220, prompt-aware generative fill manager 202 applies the input image and the generated image to a human landmark detection model (e.g., reference-point detection component 213) to identify human pose landmarks (e.g., as reference points) corresponding to the detected clothing in the input image and the generated image. In certain embodiments, content mask refinement component 212 maps the reference points of the generated image to the reference points of the input image to geometrically transform the content mask from the detected content in the generated image with respect to the content mask from the detected content in the input image. By applying a geometric transformation of the content mask from the detected content in the generated image based on the mapping of reference points between the generated image and the input image by content mask refinement component 212, the content mask from the detected content in the generated image can be aligned with the content mask from the detected content in the input image. For example, the geometric transformation applied by content mask refinement component 212 can include changes to the position, size, orientation, shape, and/or the like of the content mask from the detected content in the generated image through operations such as translation, scaling, rotation, shearing, and/or the like to align the content masks and/or reference points. In certain embodiments, content mask refinement component 212 applies a transformation matrix to map the reference points of the generated image to the reference points of the input image and geometrically transforms the content mask from the detected content in the generated image with respect to the content mask from the detected content in the input image. In certain embodiments, the geometric transformation applied by content mask refinement component 212 corresponds to an affine transformation that includes a combination of operations such as translation, scaling, rotation, shearing, and/or the like to align the content masks and/or reference points.

Content mask refinement component 212 generates a refined content mask by combining the geometrically-transformed content mask from the detected content in the generated image with the content mask from the detected content in the input image. In certain embodiments, a union operation is applied by content mask refinement component 212 to the geometrically-transformed content mask from the detected content in the generated image and the content mask from the detected content in the input image to generate the refined content mask. In certain embodiments, post-processing operations are performed by content mask refinement component 212 to generate the refined content mask after combining the geometrically-transformed content mask from the detected content in the generated image with the content mask from the detected content in the input image. In certain embodiments, post-processing operations applied by content mask refinement component 212 include operations such as dilation, alignment, thresholding, and/or the like to align the refined content mask with the content mask from the detected content in the input image.

As an example, algorithm 1 describes an example algorithm to generate a refined content mask by content mask refinement component 212 by combining a geometrically-transformed content mask from the detected content in the generated image with a content mask from the detected content in the input image:

Algorithm 1

Let Mi represent the mask derived from the input image, and Mg represent the mask
derived from the generated image. The human landmark detection model identifies
corresponding landmarks Li and Lg in both images, respectively.

| 1. | Transformation: Using the pose model, apply a transformation matrix T to | |
|---|---|---|
| | align Mg with Mi: | |
| | a. | Detect pose landmarks by identifying pose landmarks Li from the input |
| | | image and Lg from the generated image using a human landmark |
| | | detection model: |
| | | Li = detect_landmarks(input_image) |
| | | Lg = detect_landmarks(generated_image) |
| | b. | Calculate the transformation matrix T that maps landmarks Lg to Li. |
| | | This can be achieved through methods such as affine transformation, |
| | | which can involve translation, scaling, rotation, and shearing to align |
| | | the pose points: |
| | | T = calculate_transforma;on_matrix(Lg, Li) |
| | c. | Transform generated mask by applying the transformation matrix T to |
| | | the mask Mg to align it with Mi. The transformed mask from the |
| | | generated image is represented as Mg′: |
| | | Mg′ = apply_transformation(Mg, T) |

| | |
|---|---|
| 2. | Union of Masks: Create the union mask Mu that includes details from both |
| | masks: |
| | Mu = Mi ∪ Mg′ |
| 3. | Post-processing: Apply post-processing steps such as dilation D, alignment A, |
| | and thresholding Th as required: |
| | Mfinal = Th(A(D(Mu))) |

Referring to FIG. 3D, an example diagram 300D of generating a refined clothing mask 312 by a content mask refinement component 350 (e.g., content mask refinement component 212 described in connection with FIG. 2) is shown as an example implementation. As shown in example diagram 300D, the input image 302 and the generated image 306 are applied to a human landmark detection model 352 (e.g., reference-point detection component 213 described in connection with FIG. 2) of content mask refinement component 350 to identify human pose landmarks (e.g., reference points) in the input image and the generated image. Human pose landmarks 356 identified from an input image 302 are shown with respect to clothing mask 308 from detected clothing in the input image 302 and human pose landmarks 358 identified from generated image 306 are shown with respect to clothing mask 310 from detected clothing in the generated image 306 in FIG. 3D.

As can be understood, the human pose landmarks 358 of the generated image 306 are mapped to the human pose landmarks 356 of the input image 302 by refined content mask computation model 354 to geometrically transform the clothing mask 310 from the detected clothing in the generated image 306 with respect to the clothing mask 308 from the detected clothing in the input image 302. A refined clothing mask 312 is generated by refined content mask computation model 354 by combining the geometrically-transformed clothing mask from the detected clothing in the generated image 306 with the clothing mask 308 from the detected clothing in the input image 302.

Returning to FIG. 2, prompt-aware generative fill manager 202 applies the input image, input prompt, and refined content mask to a mask-aware content-generating component 214 (e.g., mask-aware content-generating model 1415A described with reference to FIG. 14A), such as a mask-aware text-to-image diffusion model, to generate content within boundaries defined by the refined content mask for the input image. For example, mask-aware content-generating component 314 can include a mask-aware text-to-image diffusion model. In certain embodiments, mask-aware content-generating component 214 can be trained and/or fine-tuned to generate the selected type of content. For example, when the user selects the option to edit the clothing in the image via the UI of the image processing application 220, the input image, input prompt, and refined clothing mask are applied to a mask-aware content-generating model of mask-aware content-generating component 214 trained and/or fine-tuned to generate clothing content within boundaries defined by the refined clothing mask. The image processing application 220 outputs the input image with the generated content 226 where the generated content is generated within the boundaries defined by the refined content mask for display via a UI of the image processing application 220 to the user. An example of an input image with generated content within a refined content mask is shown via UI 106C of FIG. 1.

Referring to FIG. 3E, an example diagram 300E of editing an input image using mask-aware content generation to generate content within a refined content mask by a mask-aware content-generating component is shown as an example implementation. As shown in example diagram 300E, the input image 302, the input prompt 304, and the refined clothing mask 312 are applied to mask-aware content-generating component 360 (e.g., mask-aware content-generating component 214 described in connection with FIG. 2) to generate content within boundaries defined by the refined clothing mask by mask-aware text-to-image diffusion model 362. The input image with generated content in refined clothing mask 314 is then output for display to the user.

### Exemplary Implementation of Image Editing Using Prompt-Aware Content Segmentation Masks and Mask-Aware Content Generation

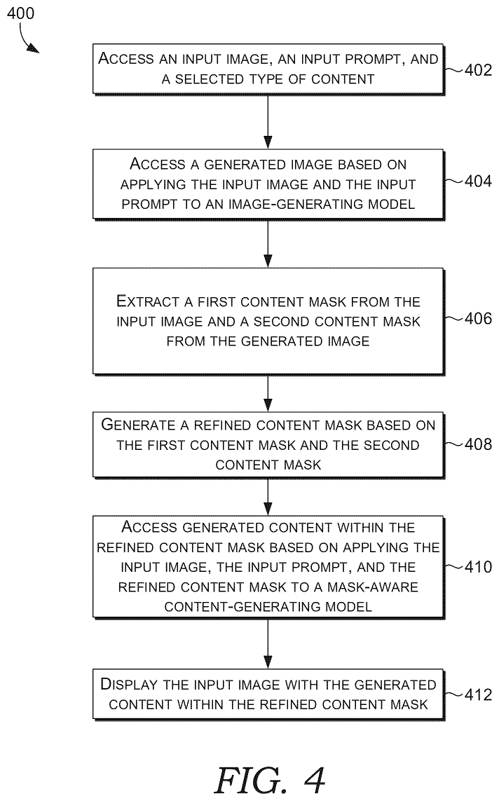

With reference now to FIGS. 4-6, FIGS. 4-6 provide method flows related to facilitating image editing using prompt-aware content segmentation masks and mask-aware content generation, in accordance with embodiments of the present technology. Each block of method 400, 500 and 600 comprises a computing process that can be performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few. The method flows of FIGS. 4-6 are exemplary only and not intended to be limiting. As can be appreciated, in some embodiments, method flows 400-600 can be implemented, at least in part, to facilitate image editing using prompt-aware content segmentation masks and mask-aware content generation.

Turning now to FIG. 4, a flow diagram 400 is provided showing an embodiment of a method 400 for image editing using prompt-aware content segmentation masks and mask-aware content generation, in accordance with embodiments described herein. Initially, at block 402, an input image, an input prompt, and a selected type of content are accessed. For example, a user inputs the input image, the input prompt, and a selection to replace a selected type of content in an input image with generated content via an interface of an image processing application.

At block 404, a generated image is accessed based on providing the input image and the input prompt to an image-generating model. For example, the image processing application causes the image-generating model to generate the generated image based on applying the input image and the input prompt to the image-generating model. In some embodiments, the image-generating model includes a feature extraction model and an image-generating diffusion model.

At block 406, a first content mask is extracted from an input image corresponding to detected content of the selected type of content in the input image and a second content mask is extracted from the generated image corresponding to detected content of the selected type of content in the generated image. For example, the image processing application applies the input image and the generated image to a content mask extraction model corresponding to a machine learning model trained to extract content masks from detected content in images for the selected type of content.

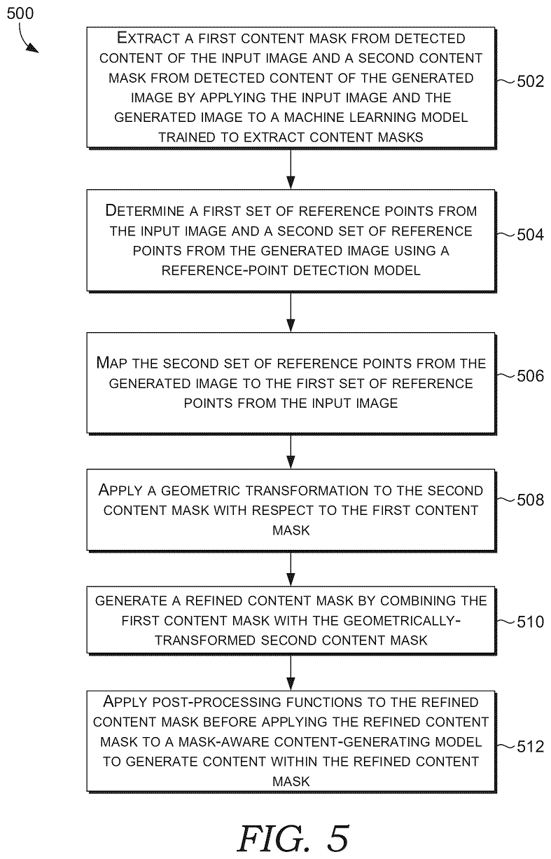

At block 408, a refined content mask is generated based on the first content mask and the second content mask. For example, the refined content mask is generated by geometrically transforming the second content mask with respect to the first content mask and/or combining the geometrically-transformed second content mask with the first content mask. Embodiments of block 408 are discussed in further detail with respect to flow diagram 500 of FIG. 5.

At block 410, generated content within the refined content mask is accessed based on applying the input image, the input prompt, and the refined content mask to a mask-aware content-generating model. For example, the mask-aware content-generating model generates content within boundaries defined by the refined content mask based on the input image and input prompt.

At block 412, the input image with the generated content within the refined content mask is displayed. For example, the input image with the content generated within the boundaries defined by the refined content mask is displayed to the user via the interface of the image processing application.

Turning now to FIG. 5, a flow diagram 500 is provided showing an embodiment of a method 500 for generating a refined content mask based on a content mask from an input image and a content mask from a generated image for image editing using prompt-aware content segmentation masks and mask-aware content generation, in accordance with embodiments described herein. Initially, at block 502, a first content mask is extracted from an input image corresponding to detected content of the selected type of content in the input image and a second content mask is extracted from the generated image corresponding to detected content of the selected type of content in the generated image by applying the input image and the generated image to a machine learning model trained to extract content masks for a selected type of content. For example, the image processing application applies the input image and the generated image to a content mask extraction model that includes the machine learning model trained to extract content masks from detected content in images for the selected type of content.

At block 504, a first set of reference points from the input image and a second set of reference points from the generated image are determined based on applying the input image and the generated image to a reference-point detection model. For example, the image processing application applies the input image and the generated image to a machine learning model trained to extract reference points from images corresponding to the selected type of content. In certain embodiments, the reference-point detection model corresponds to a human landmark detection model (e.g., a machine learning model trained to identify human pose landmarks from images) and the reference points correspond to human pose landmarks.

At block 506, the second set of reference points from the generated image are mapped to the first set of reference points from the input image and, at block 508, a geometric transformation is applied to the second content mask with respect to the first content mask. For example, a transformation matrix can be applied to second content mask to align the second set of reference points with the first set of reference points. In some embodiments, the geometric transformation includes an affine transformation to align the second set of reference points with the first set of reference points. In some embodiments, the geometric transformation includes operations, such as translation, scaling, rotation, shearing, and/or the like to align the second content mask with the first content mask. In some embodiments, the geometric transformation aligns the second content mask with the first content mask through changes to the position, size, orientation, shape, and/or the like of the second content mask with respect to the first content mask.

At block 510, a refined content mask is determined by combining the first content mask with the geometrically-transformed second content mask. For example, union operation can be applied to combine the first content mask with the second content mask after geometrically transforming the second content mask.

At block 512, post-processing functions are applied to the refined content mask before applying the refined content mask to a mask-aware content-generating model to generate content within the refined content mask. For example, post-processing functions can include operations, such as dilation, alignment, thresholding, and/or the like to align the refined content mask with the first content mask from the detected content in the input image.

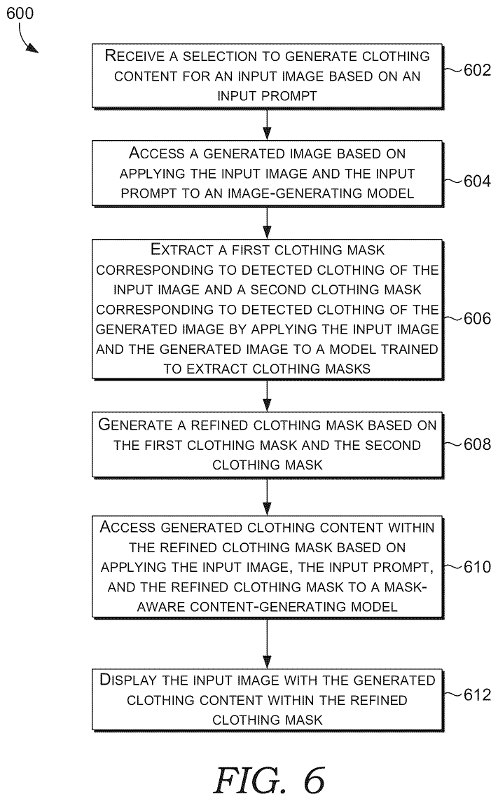

Turning now to FIG. 6, a flow diagram 600 is provided showing an embodiment of a method 600 for image editing using prompt-based clothing mask generation and clothing content filling, in accordance with embodiments described herein. Initially, at block 602, a selection to generate clothing content for an input image based on an input prompt is received by an image processing application. For example, a user inputs the input image, the input prompt, and a selection to replace clothing in an input image with generated clothing content via an interface of the image processing application.

At block 604, a generated image is accessed based on providing the input image and the input prompt to an image-generating model. For example, the image processing application causes the image-generating model to generate the generated image based on applying the input image and the input prompt to the image-generating model. In some embodiments, the image-generating model includes a feature extraction model and an image-generating diffusion model.

At block 606, a first clothing mask is extracted from an input image corresponding to detected clothing in the input image and a second clothing mask is extracted from the generated image corresponding to detected clothing in the generated image by applying the input image and the generated image to a model trained to extract clothing content masks. For example, the image processing application applies the input image and the generated image to a machine learning model trained to extract clothing masks from detected clothing in images.

At block 608, a refined clothing mask is generated based on the first clothing mask and the second clothing mask. For example, the refined clothing mask is generated by geometrically transforming the second clothing mask with respect to the first clothing mask and/or combining the geometrically-transformed second clothing mask with the first clothing mask. Embodiments of block 608 are discussed in further detail with respect to flow diagram 500 of FIG. 5.

In some embodiments, a first set of human pose landmarks are determined from the input image and a second set of human pose landmarks are determined from the generated image based on applying the input image and the generated image to a human landmark detection model. The second clothing mask is geometrically transformed with respect to the first clothing mask based on a mapping of the second set of human pose landmarks to the first set of human pose landmarks. In some embodiments, the second clothing mask is geometrically transformed with respect to the first clothing mask based on applying a transformation matrix to align the second set of human pose landmarks with the first set of human pose landmarks. In some embodiments, the second clothing mask is geometrically transformed with respect to the first clothing mask to align the second clothing mask with first clothing mask using an affine transformation. In some embodiments, the second clothing mask is geometrically transformed with respect to the first clothing mask to align the second clothing mask with first clothing mask using operations, such as translation, scaling, rotation, shearing, and/or the like. In some embodiments, the second clothing mask is geometrically transformed with respect to the first clothing mask to align the second clothing mask with first clothing mask through a change to the position, size, orientation, shape, and/or the like of the second clothing mask with respect to the first clothing mask. In some embodiments, a union operation is applied to combine the first clothing mask with the second clothing mask after geometrically transforming the second clothing mask.

At block 610, generated clothing content within the refined clothing mask is accessed based on applying the input image, the input prompt, and the refined clothing mask to a mask-aware content-generating model. For example, the mask-aware content-generating model generates clothing content within boundaries defined by the refined clothing mask based on the input image and input prompt.

At block 612, the input image with the generated clothing content within the refined clothing mask is displayed. For example, the input image with the clothing content generated within the boundaries defined by the refined clothing mask is displayed to the user via the interface of the image processing application.

### Overview of Exemplary Operating Environment

Having briefly described an overview of aspects of the technology described herein, an exemplary operating environment in which aspects of the technology described herein may be implemented is described below in order to provide a general context for various aspects of the technology described herein.

Referring to the drawings in general, and initially to FIG. 7 in particular, an exemplary operating environment for implementing aspects of the technology described herein is shown and designated generally as computing device 700. Computing device 700 is just one example of a suitable computing environment and is not intended to suggest any limitation as to the scope of use or functionality of the technology described herein. Neither should the computing device 700 be interpreted as having any dependency or requirement relating to any one or combination of components illustrated.

The technology described herein may be described in the general context of computer code or machine-usable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Aspects of the technology described herein may be practiced in a variety of system configurations, including handheld devices, consumer electronics, general-purpose computers, and specialty computing devices. Aspects of the technology described herein may also be practiced in distributed computing environments where tasks are performed by remote-processing devices that are linked through a communications network.

With continued reference to FIG. 7, computing device 700 includes a bus 710 that directly or indirectly couples the following devices: memory 712, one or more processors 714, one or more presentation components 716, input/output (I/O) ports 718, I/O components 720, an illustrative power supply 722, and a radio(s) 724. Bus 710 represents what may be one or more busses (such as an address bus, data bus, or combination thereof). Although the various blocks of FIG. 7 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art, and reiterate that the diagram of FIG. 7 is merely illustrative of an exemplary computing device that can be used in connection with one or more aspects of the technology described herein. Distinction is not made between such categories as “workstation,” “server,” “laptop,” and “handheld device,” as all are contemplated within the scope of FIG. 7 and refer to “computer” or “computing device.”

Computing device 700 typically includes a variety of computer-readable media. Computer-readable media can be any available media that can be accessed by computing device 700 and includes both volatile and nonvolatile, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program sub-modules, or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage, or other magnetic storage devices. Computer storage media does not comprise a propagated data signal.

Communication media typically embodies computer-readable instructions, data structures, program sub-modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 712 includes computer storage media in the form of volatile and/or nonvolatile memory. The memory 712 may be removable, non-removable, or a combination thereof. Exemplary memory includes solid-state memory, hard drives, and optical-disc drives. Computing device 700 includes one or more processors 714 that read data from various entities such as bus 710, memory 712, or I/O components 720. Presentation component(s) 716 present data indications to a user or other device. Exemplary presentation components 716 include a display device, speaker, printing component, and vibrating component. I/O port(s) 718 allow computing device 700 to be logically coupled to other devices including I/O components 720, some of which may be built in.

Illustrative I/O components include a microphone, joystick, game pad, satellite dish, scanner, printer, display device, wireless device, a controller (such as a keyboard, and a mouse), a natural UI (NUI) (such as touch interaction, pen (or stylus) gesture, and gaze detection), and the like. In aspects, a pen digitizer (not shown) and accompanying input instrument (also not shown but which may include, by way of example only, a pen or a stylus) are provided in order to digitally capture freehand user input. The connection between the pen digitizer and processor(s) 714 may be direct or via a coupling utilizing a serial port, parallel port, and/or other interface and/or system bus known in the art. Furthermore, the digitizer input component may be a component separated from an output component such as a display device, or in some aspects, the usable input area of a digitizer may be coextensive with the display area of a display device, integrated with the display device, or may exist as a separate device overlaying or otherwise appended to a display device. Any and all such variations, and any combination thereof, are contemplated to be within the scope of aspects of the technology described herein.

A NUI processes air gestures, voice, or other physiological inputs generated by a user. Appropriate NUI inputs may be interpreted as ink strokes for presentation in association with the computing device 700. These requests may be transmitted to the appropriate network element for further processing. A NUI implements any combination of speech recognition, touch and stylus recognition, facial recognition, biometric recognition, gesture recognition both on screen and adjacent to the screen, air gestures, head and eye tracking, and touch recognition associated with displays on the computing device 700. The computing device 700 may be equipped with depth cameras, such as stereoscopic camera systems, infrared camera systems, RGB camera systems, and combinations of these, for gesture detection and recognition. Additionally, the computing device 700 may be equipped with accelerometers or gyroscopes that enable detection of motion. The output of the accelerometers or gyroscopes may be provided to the display of the computing device 700 to render immersive augmented reality or virtual reality.

A computing device may include radio(s) 724. The radio 724 transmits and receives radio communications. The computing device may be a wireless terminal adapted to receive communications and media over various wireless networks. Computing device 700 may communicate via wireless protocols, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include a Wi-Fi® connection to a device (e.g., mobile hotspot) that provides access to a wireless communications network, such as a WLAN connection using the 802.11 protocol. A Bluetooth connection to another computing device is a second example of a short-range connection. A long-range connection may include a connection using one or more of CDMA, GPRS, GSM, TDMA, and 802.16 protocols.

The technology described herein is described with specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and “block” may be used herein to connote different elements of methods employed, the terms should not be interpreted as implying any particular order among or between various steps herein disclosed unless and except when the order of individual steps is explicitly described.

### Architecture: Pixel Diffusion

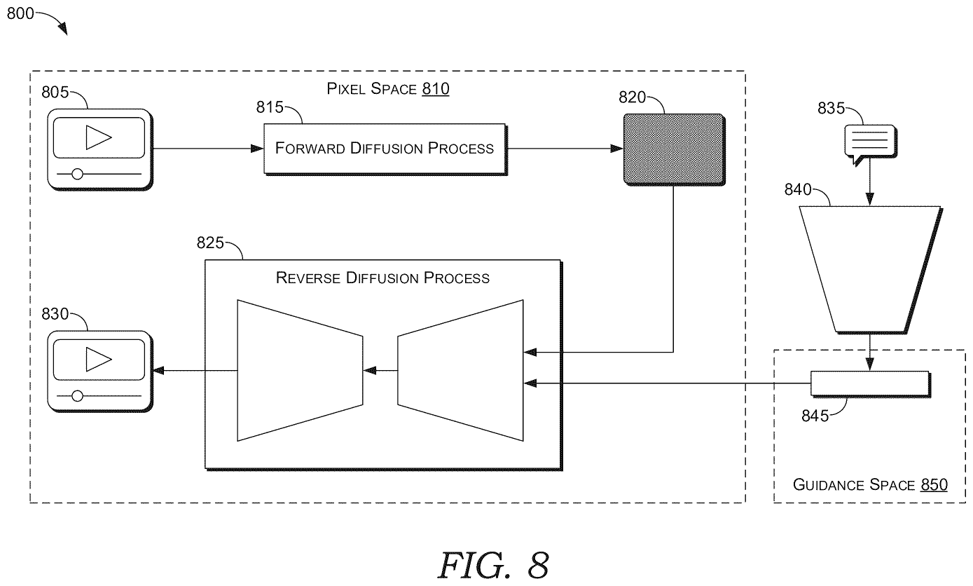

FIG. 8 shows an example of a guided diffusion model 800 according to aspects of the present disclosure. In some examples, guided diffusion model 800 describes the operation and architecture of the mask-aware content-generating model 1415A and/or image-generating model 1415B described with reference to FIGS. 14A and 14B. The guided latent diffusion model 800 depicted in FIG. 8 is an example of, or includes aspects of, a media generation model as described herein.

Diffusion models are a class of generative neural networks which can be trained to generate new data with features similar to features found in training data. In particular, diffusion models can be used to generate novel media items such as images, audio files, videos, three-dimensional (3D) models or other digital media items. Diffusion models can be used for various media processing tasks including image super-resolution, generation of media items with perceptual metrics, conditional generation (e.g., generation based on text guidance), image inpainting, and media manipulation.

Diffusion models work by iteratively adding noise to the data during a forward process and then learning to recover the data by denoising the data during a reverse process. For example, during training, guided latent diffusion model 800 may take an original media item 805 in a pixel space 810 as input and apply forward diffusion process 830 to gradually add noise to the original media item 805 to obtain noisy media item 820 at various noise levels.

Next, a reverse diffusion process 825 (e.g., a U-Net) gradually removes the noise from the noisy media item 820 at the various noise levels to obtain an output media item 830. In some cases, an output media item 830 is created from each of the various noise levels. The output media item 830 can be compared to the original media item 805 to train the reverse diffusion process 825.

The reverse diffusion process 825 can also be guided based on a text prompt 835, or another guidance prompt, such as an image, a layout, a segmentation map, etc. The text prompt 835 can be encoded using a text encoder 865 (e.g., a multimodal encoder) to obtain guidance features 845 in guidance space 850. The guidance features 845 can be combined with the noisy media item 820 at one or more layers of the reverse diffusion process 825 to ensure that the output media item 830 includes content described by the text prompt 835. For example, guidance features 845 can be combined with the noisy features using a cross-attention block within the reverse diffusion process 825.

Methods of operating diffusion models include a Denoising Diffusion Probabilistic Model (DDPM) and a Denoising Diffusion Implicit Models (DDIM). In DDPM, the generative process includes reversing a stochastic Markov diffusion process. DDIMs, on the other hand, use a deterministic process so that the same input results in the same output. In some cases, DDIM can reduce the number of timesteps during media generation. Diffusion models may also be characterized by whether the noise is added to the media item itself, or to media features generated by an encoder (i.e., latent diffusion). In a pixel diffusion model, noise is added and removed in pixel space. In a latent diffusion model, the noise is added (and removed) in a latent space of media features rather than in pixel space. Thus, a latent diffusion model generates media features using reverse diffusion, and these media features can be decoded to obtain a synthetic media item.

### Architecture: U-Net

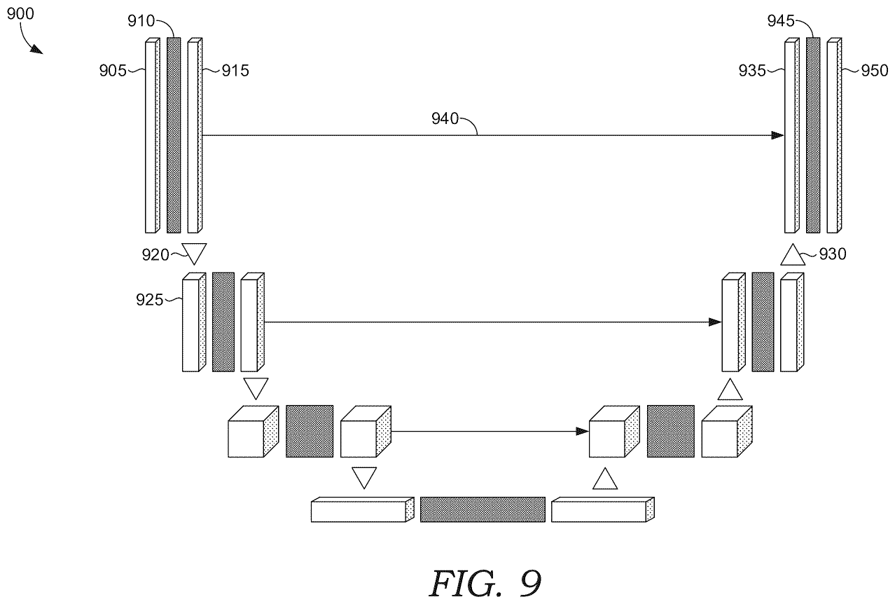

FIG. 9 shows an example of a U-Net 900 according to aspects of the present disclosure. In some examples, U-Net 900 is an example of the component that performs the reverse diffusion process 825 of guided diffusion model 800 described with reference to FIG. 8 and includes architectural elements of the mask-aware content-generating model 1415A and/or image-generating model 1415B described with reference to FIGS. 14A and 14B. The U-Net 900 depicted in FIG. 9 is an example of, or includes aspects of, the architecture used within the reverse diffusion process described with reference to FIG. 8.

In some examples, diffusion models are based on a neural network architecture known as a U-Net. The U-Net 900 takes input features 905 having an initial resolution and an initial number of channels and processes the input features 905 using an initial neural network layer 910 (e.g., a convolutional network layer) to produce intermediate features 915. The intermediate features 915 are then down-sampled using a down-sampling layer 920 such that down-sampled features 925 features have a resolution less than the initial resolution and a number of channels greater than the initial number of channels.

This process is repeated multiple times, and then the process is reversed. That is, the down-sampled features 925 are up-sampled using up-sampling process 930 to obtain up-sampled features 935. The up-sampled features 935 can be combined with intermediate features 915 having the same resolution and number of channels via a skip connection 940. These inputs are processed using a final neural network layer 945 to produce output features 950. In some cases, the output features 950 have the same resolution as the initial resolution and the same number of channels as the initial number of channels.

In some cases, U-Net 900 takes additional input features to produce conditionally generated output. For example, the additional input features could include a vector representation of an input prompt. The additional input features can be combined with the intermediate features 915 within the neural network at one or more layers. For example, a cross-attention module can be used to combine the additional input features and the intermediate features 915.

### Inference: Conditional Generation

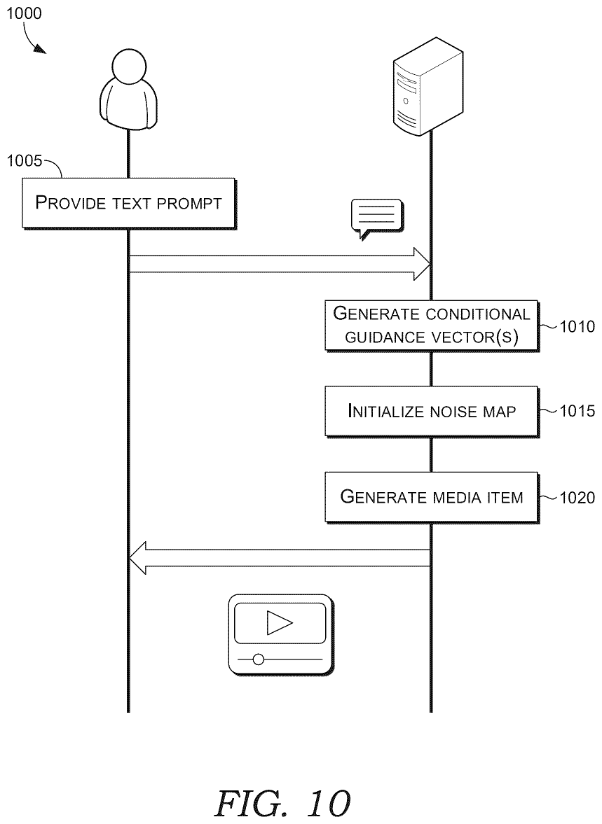

FIG. 10 shows an example of a method 1000 for conditional media generation according to aspects of the present disclosure. In some examples, method 1000 describes an operation of the mask-aware content-generating model 1415A and/or image-generating model 1415B described with reference to FIGS. 14A and 14B such as an application of the guided diffusion model 100 described with reference to FIG. 8. In some examples, these operations are performed by a system including a processor executing a set of codes to control functional elements of an apparatus such as the media generation model described in FIG. 8.

Additionally or alternatively, steps of the method 1000 may be performed using special-purpose hardware. Generally, these operations are performed according to the methods and processes described in accordance with aspects of the present disclosure. In some cases, the operations described herein are composed of various substeps, or are performed in conjunction with other operations.

At operation 1005, a user provides a text prompt describing content to be included in a generated media item. For example, a user may provide the prompt “a person playing with a cat”. In some examples, guidance can be provided in a form other than text, such as via an image, a sketch, or a layout.

At operation 1010, the system converts the text prompt (or other guidance) into a conditional guidance vector or other multi-dimensional representation. For example, text may be converted into a vector or a series of vectors using a transformer model, or a multi-modal encoder. In some cases, the encoder for the conditional guidance is trained independently of the diffusion model.

At operation 1015, a noise map is initialized that includes random noise. The noise map may be in a pixel space or a latent space. By initializing a media item with random noise, different variations of a media item including the content described by the conditional guidance can be generated.

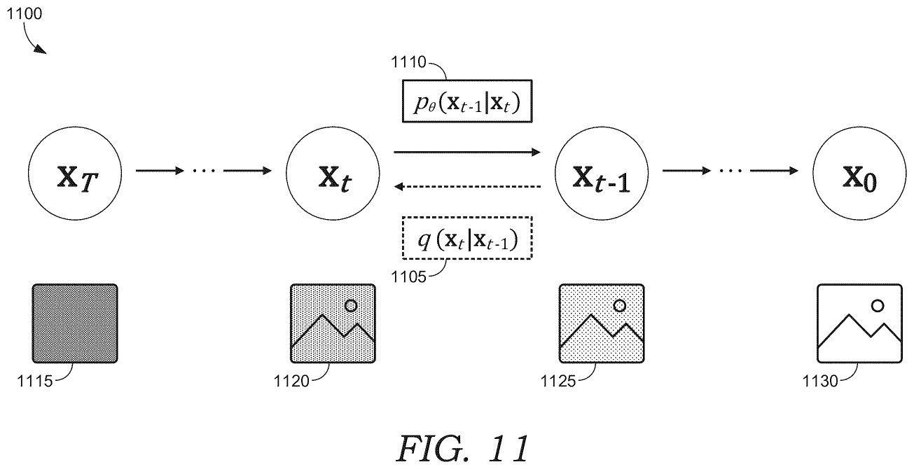

At operation 1020, the system generates a media item based on the noise map and the conditional guidance vector. For example, the media item may be generated using a reverse diffusion process as described with reference to FIG. 11.

### Inference: Reverse Diffusion

FIG. 11 shows a diffusion process 1100 according to aspects of the present disclosure. In some examples, diffusion process 1100 describes an operation of the mask-aware content-generating model 1415A and/or image-generating model 1415B described with reference to FIGS. 14A and 14B, such as the reverse diffusion process 825 of guided diffusion model 800 described with reference to FIG. 8.

As described above with reference to FIG. 8, using a diffusion model can involve both a forward diffusion process 1105 for adding noise to a media item (or features in a latent space) and a reverse diffusion process 1110 for denoising the media item (or features) to obtain a denoised media item. The forward diffusion process 1105 can be represented as q(xₜ|xₜ₋₁), and the reverse diffusion process 1110 can be represented as p(xₜ₋₁|xₜ). In some cases, the forward diffusion process 1105 is used during training to generate media items with successively greater noise, and a neural network is trained to perform the reverse diffusion process 1110 (i.e., to successively remove the noise).

In an example forward process for a latent diffusion model, the model maps an observed variable x, (either in a pixel space or a latent space) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse process. During the reverse diffusion process 1110, the model begins with noisy data x_{T}, such as a noisy media item 1115 and denoises the data to obtain the p(xₜ₋₁|xₜ). At each step t−1, the reverse diffusion process 1110 takes xₜ, such as first intermediate media item 1120, and t as input. Here, t represents a step in the sequence of transitions associated with different noise levels, The reverse diffusion process 1110 outputs xₜ₋₁, such as second intermediate media item 1125 iteratively until x_{T} reverts back to x₀, the original media item 1130. The reverse process can be represented as:

$${p}_{θ} ( {x}_{t - 1} \vert {x}_{t} ) : = N ( {x}_{t - 1} ; {μ}_{θ} ( {x}_{t} , t ) , {\sum }_{θ} ( {x}_{t} , t ) ) . \qquad ( 1 )$$

The joint probability of a sequence of samples in the Markov chain can be written as a product of conditionals and the marginal probability:

$${x}_{T} : {p}_{θ} ( {x}_{0 : T} ) : = p ( {x}_{T} ) {\prod }_{t = 1}^{T} {p}_{θ} ( {x}_{t - 1} \vert {x}_{t} ) , \qquad ( 2 )$$

where p(x_{T})=N(x_{T};0,I) is the pure noise distribution as the reverse process takes the outcome of the forward process, a sample of pure noise, as input and

$${\prod }_{t = 1}^{T} {p}_{θ} ( {x}_{t - 1} \vert {x}_{t} )$$

represents a sequence of Gaussian transitions corresponding to a sequence of addition of Gaussian noise to the sample.

At interference time, observed data x₀ in a pixel space can be mapped into a latent space as input and a generated data \tilde{x} is mapped back into the pixel space from the latent space as output. In some examples, x₀ represents an original input media item with low quality, latent variables x₁, . . . , x_{T} represent noisy media items, and \tilde{x} represents the generated item with high quality.

### Training: Machine Learning

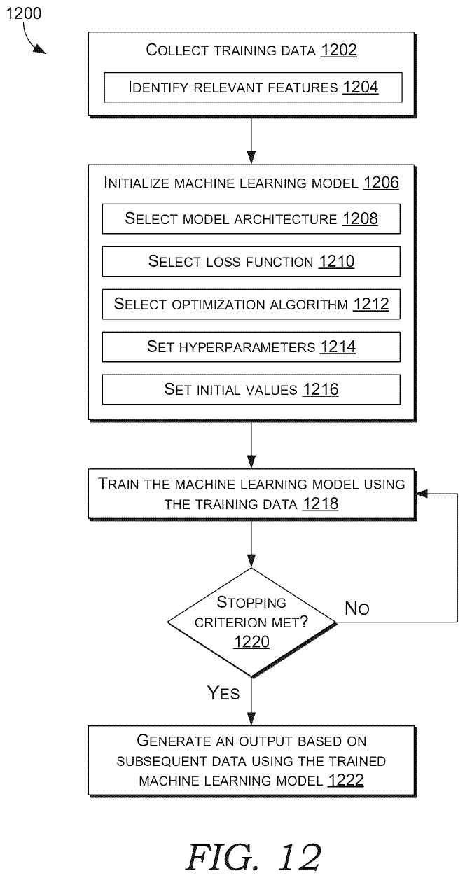

FIG. 12 is a flow diagram depicting an algorithm as a step-by-step procedure 1200 in an example implementation of operations performable for training a machine-learning model. In some embodiments, the procedure 1200 describes an operation of the training component 1425 described for configuring the mask-aware content-generating model 1415A and/or image-generating model 1415B described with reference to FIGS. 14A and 14B. The procedure 1200 provides one or more examples of generating training data, use of the training data to train a machine-learning model, and use of the trained machine-learning model to perform a task.

To begin in this example, a machine-learning system collects training data (block 1202) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 1204) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

In order to train the machine-learning model in the illustrated example, the machine-learning model is first initialized (block 1206). Initialization of the machine-learning model includes selecting a model architecture (block 1208) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 1210). The loss function is utilized to measure a difference between an output of the machine-learning model (i.e., predictions) and target values (e.g., as expressed by the training data) to be used to train the machine-learning model. Additionally, an optimization algorithm is selected (1212) that is to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 1214) examples of which includes initializing weights and biases of nodes to improve efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 1218) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 1220), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1220), the procedure 1200 continues training of the machine-learning model using the training data (block 1218) in this example.

If the stopping criterion is met (“yes” from decision block 1220), the trained machine-learning model is then utilized to generate an output based on subsequent data (block 1222). The trained machine-learning model, for instance, is trained to perform a task as described above and therefore once trained is configured to perform that task based on subsequent data received as an input and processed by the machine-learning model.

### Training: Diffusion Training

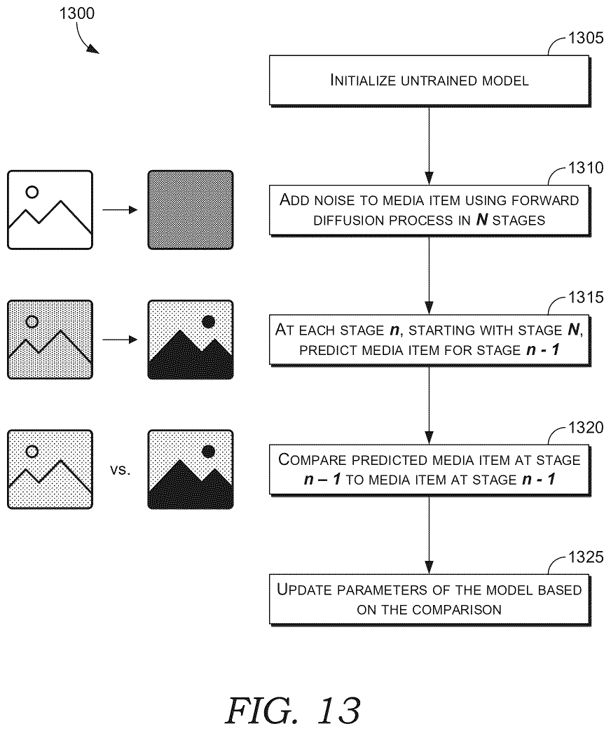

FIG. 13 shows an example of a method 1300 for training a diffusion model according to aspects of the present disclosure. In some embodiments, the method 1300 describes an operation of the training component 1425 described for configuring the mask-aware content-generating model 1415A and/or image-generating model 1415B described with reference to FIGS. 14A and 14B. The method 1300 represents an example for training a reverse diffusion process as described above with reference to FIG. 11. In some examples, these operations are performed by a system including a processor executing a set of codes to control functional elements of an apparatus, such as the guided diffusion model described in FIG. 8.

Additionally or alternatively, certain processes of method 1300 may be performed using special-purpose hardware. Generally, these operations are performed according to the methods and processes described in accordance with aspects of the present disclosure. In some cases, the operations described herein are composed of various substeps, or are performed in conjunction with other operations.

At operation 1305, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

At operation 1310, the system adds noise to a media item using a forward diffusion process in N stages. In some cases, the forward diffusion process is a fixed process where Gaussian noise is successively added to media item. In latent diffusion models, the Gaussian noise may be successively added to features in a latent space.

At operation 1315, the system at each stage n, starting with stage N, a reverse diffusion process is used to predict the output or features at stage n−1. For example, the reverse diffusion process can predict the noise that was added by the forward diffusion process, and the predicted noise can be removed from the noise input to obtain the predicted output. In some cases, an original media item is predicted at each stage of the training process.

At operation 1320, the system compares predicted output (or features) at stage n−1 to an actual media item (or features), such as the output at stage n−1 or the original input. For example, given observed data x, the diffusion model may be trained to minimize the variational upper bound of the negative log-likelihood-log pe (x) of the training data.

At operation 1325, the system updates parameters of the model based on the comparison. For example, parameters of a U-Net may be updated using gradient descent. Time-dependent parameters of the Gaussian transitions can also be learned.

### System: Computing Device

FIG. 7 shows an example of a computing device 700 according to aspects of the present disclosure. The computing device 700 may be an example of the mask-aware content-generating apparatus 1400A and image-generating apparatus 1400B described with reference to FIGS. 14A and 14B. In one aspect, computing device 700 includes a processor(s) 714, a memory subsystem, such as memory 712, a communication interface, such as radio 724, an I/O interface, such as I/O port(s) 718, a user interface component(s), such as I/O components 720, and a channel, such as bus 710.

In some embodiments, computing device 700 is an example of, or includes aspects of, the media generation model of FIG. 8. In some embodiments, computing device 700 includes one or more processors 714 that can execute instructions stored in memory subsystem, such as memory 712, to perform media generation.

According to some aspects, computing device 700 includes one or more processors 714. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem, such as memory 712, includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface, such as radio 724, operates at a boundary between communicating entities (such as computing device 700, one or more user devices, a cloud, and one or more databases) and channel, such as bus 710, and can record and process communications. In some cases, a communication interface is provided to enable a processing system coupled to a transceiver (e.g., a transmitter and/or a receiver). In some examples, the transceiver is configured to transmit (or send) and receive signals for a communications device via an antenna.

According to some aspects, I/O interface, such as I/O port(s) 718, is controlled by an I/O controller to manage input and output signals for computing device 700. In some cases, the I/O interface manages peripherals not integrated into computing device 700. In some cases, the I/O interface represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via the I/O interface or via hardware components controlled by the I/O controller.

According to some aspects, user interface component(s), such as I/O components 720, enable a user to interact with computing device 700. In some cases, the user interface component(s) include an audio device, such as an external speaker system, an external display device such as a display screen, an input device (e.g., a remote-control device interfaced with a user interface directly or through the I/O controller), or a combination thereof. In some cases, the user interface component(s) include a GUI.

### System: Mask-Aware Content-Generating Apparatus and Image-Generating Apparatus

FIG. 14A shows an example of a mask-aware content-generating apparatus 1400A according to aspects of the present disclosure. Mask-aware content-generating apparatus 1400A may include an example of, or aspects of, the guided diffusion model described with reference to FIG. 8 and the U-Net described with reference to FIG. 9. In some embodiments, mask-aware content-generating apparatus 1400A includes processor unit 1405A, memory unit 1410A, mask-aware content-generating model 1415A, I/O module 1420A, and training component 1425A. Training component 1425A updates parameters of the mask-aware content-generating model 1415A stored in memory unit 1410A. In some examples, the training component 1425A is located outside the mask-aware content-generating apparatus 1400A.

FIG. 14B shows an example of an image-generating apparatus 1400B according to aspects of the present disclosure. Image-generating apparatus 1400B may include an example of, or aspects of, the guided diffusion model described with reference to FIG. 8 and the U-Net described with reference to FIG. 9. In some embodiments, image-generating apparatus 1400B includes processor unit 1405B, memory unit 1410B, image-generating model 1415B, I/O module 1420B, and training component 1425B. Training component 1425B updates parameters of the image-generating model 1415B stored in memory unit 1410B. In some examples, the training component 1425B is located outside the mask-aware content-generating apparatus 1400B.

Processor units 1405A-B include one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some cases, processor units 1405A-B are configured to operate a memory array using a memory controller. In other cases, a memory controller is integrated into processor units 1405A-B. In some cases, processor units 1405A-B are configured to execute computer-readable instructions stored in memory units 1410A-B to perform various functions. In some aspects, processor unit 1405A-B include special purpose components for modem processing, baseband processing, digital signal processing, or transmission processing. According to some aspects, processor units 1405A-B comprise one or more processors described with reference to FIG. 7.

Memory units 1410 A-B include one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor units 1405A-B to perform various functions described herein.

In some cases, memory units 1410A-B include a basic input/output system (BIOS) that controls basic hardware or software operations, such as an interaction with peripheral components or devices. In some cases, memory units 1410A-B include a memory controller that operates memory cells of memory units 1410A-B. For example, the memory controller may include a row decoder, column decoder, or both. In some cases, memory cells within memory units 1410A-B store information in the form of a logical state. According to some aspects, memory units 1410A-B are examples of the memory subsystem, such as memory 712 described with reference to FIG. 7.

According to some aspects, mask-aware content-generating apparatus 1400A uses one or more processors of processor unit 1405A to execute instructions stored in memory unit 1410A to perform functions described herein. For example, the mask-aware content-generating apparatus 1400A (e.g., mask-aware content-generating component 214 described with reference to FIG. 2) may generate content within boundaries defined by a mask based on an input prompt, a mask, and/or an input image.

The memory unit 1410A may include a mask-aware content-generating model 1415A trained to generate content within boundaries defined by a mask based on an input prompt, a mask, and/or an input image. For example, after training, the mask-aware content-generating model 1415A may perform inferencing operations as described with reference to FIGS. 10 and 11 to generate content within boundaries defined by a mask based on an input prompt, a mask, and/or an input image.

According to some aspects, image-generating apparatus 1400B uses one or more processors of processor unit 1405B to execute instructions stored in memory unit 1410B to perform functions described herein. For example, the image-generating apparatus 1400B (e.g., image-generating component 208 described with reference to FIG. 2) may generate a new image based on an input prompt, an input image, and/or extracted features from the input image.

The memory unit 1410B may include an image-generating model 1415B trained to generate a new image based on an input prompt, an input image, and/or extracted features from the input image. For example, after training, the image-generating model 1415B may perform inferencing operations as described with reference to FIGS. 10 and 11 to generate a new image based on an input prompt, an input image, and/or extracted features from the input image.

In some embodiments, the mask-aware content-generating model 1415A and/or image-generating model 1415B is an Artificial neural network (ANN) such as the guided diffusion model described with reference to FIG. 8 and the U-Net described with reference to FIG. 9. An ANN can be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of mask-aware content-generating model 1415A and/or image-generating model 1415B can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

Training component 1425A-B may train the mask-aware content-generating model 1415A and/or image-generating model 1415B, respectively. For example, parameters of the mask-aware content-generating model 1415A and/or image-generating model 1415B can be learned or estimated from training data and then used to make predictions or perform tasks based on learned patterns and relationships in the data. In some examples, the parameters are adjusted during the training process to minimize a loss function or maximize a performance metric (e.g., as described with reference to FIGS. 12 and 13). The goal of the training process may be to find optimal values for the parameters that allow the machine learning model to make accurate predictions or perform well on the given task.

Accordingly, the node weights can be adjusted to improve the accuracy of the output (i.e., by minimizing a loss which corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the mask-aware content-generating model 1415A and/or image-generating model 1415B can be used to make predictions on new, unseen data (i.e., during inference).

I/O modules 1420A-B receive inputs from and transmits outputs of the mask-aware content-generating apparatus 1400A and image-generating apparatus 1400B, respectively, to other devices or users. For example, I/O modules 1420A-B receive inputs for the mask-aware content-generating model 1415A and image-generating apparatus 1400B, respectively, and transmits outputs of the mask-aware content-generating model 1415A and image-generating apparatus 1400B, respectively. According to some aspects, I/O modules 1420A-B are examples of the I/O interface, such as I/O port(s) 718 described with reference to FIG. 7.

What is claimed is:

1. A method comprising:
generating a refined content mask by geometrically transforming a first content mask extracted from a new image generated based on an image and a prompt with respect to a second content mask extracted from the image;
generating, via a generative artificial intelligence model, content within boundaries defined by the refined content mask based on the image, the prompt, and the refined content mask; and
causing display of the image with the content within the boundaries defined by the refined content mask.

2. The method of claim 1, wherein generating the refined content mask further comprises:
determining a first set of reference points from the new image and a second set of reference points from the image based on applying the new image and the image to a reference-point detection model;
geometrically transforming the first content mask with respect to the second content mask based on a mapping of the first set of reference points to the second set of reference points; and
combining the first content mask with the second content mask after geometrically transforming the first content mask.

3. The method of claim 1, wherein generating the refined content mask further comprises:
determining a first set of reference points from the new image and a second set of reference points from the image based on applying the new image and the image to a reference-point detection model;
geometrically transforming the first content mask with respect to the second content mask based on applying a transformation matrix to align the first set of reference points with the second set of reference points; and
combining the first content mask with the second content mask after geometrically transforming the first content mask.

4. The method of claim 1, wherein generating the refined content mask further comprises:
geometrically transforming the first content mask with respect to the second content mask to align the first content mask with second content mask using an affine transformation; and
applying a union operation to combine the first content mask with the second content mask after geometrically transforming the first content mask.

5. The method of claim 1, wherein generating the refined content mask further comprises:
geometrically transforming the first content mask with respect to the second content mask to align the first content mask with second content mask through at least one of translation, scaling, rotation and shearing; and
applying a union operation to combine the first content mask with the second content mask after geometrically transforming the first content mask.

6. The method of claim 1, wherein generating the refined content mask further comprises:
geometrically transforming the first content mask with respect to the second content mask to align the first content mask with second content mask through a change to at least one of position, size, orientation, and shape of the first content mask with respect to the second content mask; and
applying a union operation to combine the first content mask with the second content mask after geometrically transforming the first content mask.

7. The method of claim 1, further comprising:
extracting the first content mask and the second content mask by a machine learning model trained to extract content masks from detected content in images for a selected type of content.

8. The method of claim 1, further comprising:
generating the new image based on applying the image and the prompt to an image-generating model, the image-generating model comprising a feature extraction model and an image-generating diffusion model; and
generating the content based on applying the image, the prompt, and the refined content mask to a mask-aware content generating model comprising the generative artificial intelligence model.

9. A system comprising:
a memory component; and
a processing device coupled to the memory component, the processing device to perform operations comprising:
responsive to an indication to generate new content to replace particular content in a particular image:
generating a refined content mask by geometrically transforming a first content mask extracted from a new image generated based on the particular image and a prompt with respect to a second content mask extracted from the particular image; and
causing display of the particular image with the new content within boundaries defined by the refined content mask, the new content generated based on the particular image, the prompt, and the refined content mask.

10. The system of claim 9, wherein generating the refined content mask further comprises:
determining a first set of reference points from the new image and a second set of reference points from the particular image based on applying the new image and the particular image to a reference-point detection model;
geometrically transforming the first content mask with respect to the second content mask based on a mapping of the first set of reference points to the second set of reference points; and
combining the first content mask with the second content mask after geometrically transforming the first content mask.

11. The system of claim 9, wherein generating the refined content mask further comprises:
determining a first set of reference points from the new image and a second set of reference points from the particular image based on applying the new image and the particular image to a reference-point detection model;
geometrically transforming the first content mask with respect to the second content mask based on applying a transformation matrix to align the first set of reference points with the second set of reference points; and
combining the first content mask with the second content mask after geometrically transforming the first content mask.

12. The system of claim 9, wherein generating the refined content mask further comprises:
geometrically transforming the first content mask with respect to the second content mask to align the first content mask with second content mask using an affine transformation; and
applying a union operation to combine the first content mask with the second content mask after geometrically transforming the first content mask.

13. The system of claim 9, wherein generating the refined content mask further comprises:
geometrically transforming the first content mask with respect to the second content mask to align the first content mask with second content mask through at least one of translation, scaling, rotation and shearing; and
applying a union operation to combine the first content mask with the second content mask after geometrically transforming the first content mask.

14. The system of claim 9, wherein generating the refined content mask further comprises:
geometrically transforming the first content mask with respect to the second content mask to align the first content mask with second content mask through a change to at least one of position, size, orientation, and shape of the first content mask with respect to the second content mask; and
applying a union operation to combine the first content mask with the second content mask after geometrically transforming the first content mask.

15. The system of claim 9, the operations further comprising:
extracting the first content mask and the second content mask by a machine learning model trained to extract content masks from detected content in images for a corresponding type of the particular content.

16. The system of claim 9, the operations further comprising:
generating the new image based on applying the particular image and the prompt to an image-generating model, the image-generating model comprising a feature extraction model and an image-generating diffusion model; and
generating the new content based on applying the particular image, the prompt, and the refined content mask to a mask-aware content generating model.

17. A non-transitory computer-readable medium storing executable instructions, which when executed by a processing device, cause the processing device to perform operations comprising:
obtaining an indication to generate new content to replace particular content in a particular image and a prompt indicating the new content;
generating a refined content mask by geometrically transforming a first content mask extracted from a new image generated based on the particular image and the prompt with respect to a second content mask extracted from the particular image;
generating, via a generative artificial intelligence model, the new content within boundaries defined by the refined content mask based on the particular image, the prompt, and the refined content mask; and
causing display of the particular image with the new content.

18. The non-transitory computer-readable medium of claim 17, wherein generating the refined content mask further comprises:
determining a first set of reference points from the new image and a second set of reference points from the particular image based on applying the new image and the particular image to a reference-point detection model;
geometrically transforming the first content mask with respect to the second content mask based on a mapping of the first set of reference points to the second set of reference points; and
combining the first content mask with the second content mask after geometrically transforming the first content mask.

19. The non-transitory computer-readable medium of claim 17, wherein generating the refined content mask further comprises:
determining a first set of reference points from the new image and a second set of reference points from the particular image based on applying the new image and the particular image to a reference-point detection model;
geometrically transforming the first content mask with respect to the second content mask based on applying a transformation matrix to align the first set of reference points with the second set of reference points; and
combining the first content mask with the second content mask after geometrically transforming the first content mask.

20. The non-transitory computer-readable medium of claim 17, wherein generating the refined content mask further comprises:
geometrically transforming the first content mask with respect to the second content mask to align the first content mask with second content mask using an affine transformation; and
applying a union operation to combine the first content mask with the second content mask after geometrically transforming the first content mask.
